(19) United States
(12) Patent Application Publication
(10) Pub. No.: US 2026/0362151 A1
(43) Pub. Date: Nov. 12, 2026

(54) COEXISTENCE SCENARIOS AND INTERFERENCE MANAGEMENT AND TN-NTN COORDINATION

(71) Applicant: Fraunhofer-Gesellschaft zur Förderung der angewandten Forschung e.V., München (DE)

(72) Inventors: Thomas HAUSTEIN, Berlin (DE); Paul Simon Holt LEATHER, Berlin (DE)

(21) Appl. No.: 19/714,745

(22) Filed: Jun. 22, 2026

Related U.S. Application Data
(63) Continuation of application No. PCT/EP2024/087831, filed on Dec. 20, 2024.

(30) Foreign Application Priority Data
Dec. 21, 2023 (EP) 23219541.2

(51) Int. Cl. H04W 16/14

(52) U.S. Cl. CPC H04W 16/14

(57) ABSTRACT

A wireless communication scenario has a first wireless communication system, WCS, adapted to provide wireless communication to a plurality of communication devices in a first communication area; and a second wireless communication system, WCS, adapted to provide wireless communication to a plurality of communication devices; in a second communication area; wherein the first WCS and/or the second WCS provide a source of inter-WCS interference for the respective other WCS; wherein the wireless communication scenario is adapted to mitigate the inter-WCS interference.

### CROSS-REFERENCE TO RELATED APPLICATIONS

This application is a continuation of copending International Application No. PCT/EP2024/087831, filed Dec. 20, 2024, which is incorporated herein by reference in its entirety, and additionally claims priority from European Application No. 23219541.2, filed Dec. 21, 2023, which is also incorporated herein by reference in its entirety.

### TECHNICAL FIELD

Embodiments of the present application relate to the field of wireless communication, and more specifically, to signal processing used for the wireless communication. Some embodiments relate to providing a low physical layer, PHY, flexible radio link.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”. Embodiments described herein are not limited to terrestrial networks, TNs, but relate also to networks being implemented, at least in parts, as non-terrestrial network, NTN, as shown in FIG. 1 with reference to a satellite S1 that may operate, for example, to bridge communication between different base stations, to serve one or more UE and/or a cell on the ground, e.g., as a non-terrestrial base station, to communicate with a different satellite.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

In an in-coverage scenario in which two UEs directly communicating with each other are both connected to a base station, the base station gNB has a coverage area that is schematically represented by the circle 200 which, basically, corresponds to the cell schematically represented in FIG. 1. The UEs directly communicating with each other may be both in the coverage area of the base station gNB. Both UEs are possibly connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

In an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. UEs may directly communicate with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the out-of-coverage scenario does not necessarily mean that the respective mode 2 UEs (in NR) or mode 4 UEs (in LTE) are outside of the coverage of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area, in addition to the NR mode 1 or LTE mode 3 UEs also NR mode 2 or LTE mode 4 UEs are present.

Naturally, it is also possible that one of the UEs is covered by the gNB, i.e. connected with Uu to the gNB, wherein the second UE is not covered by the gNB and only connected via the PC5 interface to the first UE, or that the second vehicle is connected via the PC5 interface to the first vehicle UE but via Uu to another gNB.

With an increase of an amount of communication and with an increase of requirements interference is an important issue for wireless communication.

There is, thus, a need to improve wireless communications.

It is noted that the information in the above section is only for enhancing the understanding of the background of the invention and therefore it may contain information that does not form prior art and is already known to a person of ordinary skill in the art.

### SUMMARY

An embodiment may have a wireless communication scenario having: a first wireless communication system, WCS, adapted to provide wireless communication to a plurality of communication devices in a first communication area; a second wireless communication system, WCS, adapted to provide wireless communication to a plurality of communication devices; in a second communication area; wherein the first WCS and/or the second WCS provide a source of inter-WCS interference for the respective other WCS; wherein the wireless communication scenario is adapted to mitigate the inter-WCS interference.

Another embodiment may have a communication device, operating in the first WCS or the second WCS a wireless communication scenario according to the invention as mentioned above.

Another embodiment may have a coordinating node, operating in the first WCS or the second WCS a wireless communication scenario according to the invention as mentioned above.

Another embodiment may have a method for operating at least one device of the first WCS or the second WCS a wireless communication scenario according to the invention as mentioned above.

Another embodiment may have a computer readable digital storage medium having stored thereon a computer program having a program code for performing, when running on a computer, a method according to the invention as mentioned above.

### BRIEF DESCRIPTION OF THE DRAWINGS

Embodiments of the present invention are described herein making reference to the appended drawings, in which:

FIGS. 1A and 1B show a schematic representation of an example of a wireless communication system;

FIG. 2 is a schematic representation of a wireless communication system comprising a transceiver, like a base station or a relay, and a plurality of communication devices, like UEs, according to an embodiment;

FIG. 3 shows a world map showing the three Regions defined by the ITU;

FIG. 4 shows a schematic illustration of an intra-carrier interference experienced between devices/entities of neighbouring cells (WCS);

FIG. 5 shows a schematic block diagram of a WCS related to embodiments comprising one or more base stations;

FIG. 6 shows a schematic block diagram of a WCS according to an embodiment having a combinations of WCS1 & WCS2;

FIG. 7 shows an illustration of several interference mechanisms related to embodiments, affecting two wireless communication systems;

FIG. 8 shows a more detailed illustration for scheduling UEs in slots 1-3 similar to FIG. 7;

FIG. 9 shows a schematic diagram of two UEs that operate under heavy traffic conditions, similar to FIG. 8;

FIG. 10 shows a schematic illustration of interference scenarios in a sub-band full duplex, SBFD, configuration following solution ideas to form embodiments of the present invention;

FIG. 11 shows a schematic illustration of an outdoor-to-indoor cross-link interference scenario according to an embodiment;

FIG. 12 shows schematic diagrams of possible implementations of flexible slots according to embodiments and relates to different options of arranging uplink and downlink bandwidth parts, BWP;

FIG. 13 shows schematic diagrams of possible implementations of flexible slots according to embodiments and relates to inter-MNO issues;

FIG. 14 shows schematic diagrams of possible implementations of flexible slots according to embodiments and relates to concepts of cooperation and collaboration relating to the behavior;

FIG. 15 shows schematic diagrams of possible implementations of flexible slots according to embodiments and relates to a BTS as an uplink as an receiver being a victim;

FIG. 16 shows overlapping allocation of spectrum to mobile satellite service (MSS) and international mobile telecommunications (IMT) services;

FIG. 17 shows a potential interference scenario in C band;

FIG. 18 a schematic representation of consider the E-UTRA bands 23, 32 and NR bands n66 and n70;

FIG. 19 shows numerical details of FIG. 18;

FIG. 20 presents a view of EUTRA band 66 (also NR band n66) according to an embodiment;

FIG. 21 shows an example of a two MNOs' channel bandwidth allocation in band 66; according to an embodiment;

FIG. 22 shows the addition of a third MNO according to another embodiment;

FIG. 23 shows an example S-parameter description of a band 66 small-cell basestation duplex filter;

FIG. 24 shows a pictorial presentation of a satellite providing services to a UE and a BTS providing services to a UE according to an embodiment;

FIG. 25 shows an example of BTS-to-satellite cross-link interference (CLI) according to an embodiment;

FIG. 26 shows an example of BTS-to-UE1 co-channel interference (CCI) according to an embodiment;

FIG. 27 shows an example of Satellite-to-UE2 co-channel interference (CCI) according to an embodiment;

FIG. 28 shows an example of UE1-to-UE2 cross-link interference (CLI) according to an embodiment;

FIG. 29 shows a table summarizing details of the four potential interference situations drawn in FIG. 25 to FIG. 28;

FIGS. 30A-30C show a diagrammatic representation of the ICIC (A) solution proposal applied according to embodiments;

FIG. 31 shows a diagrammatic representation of a relationship between bands of a terrestrial network, TN, and of a non-terrestrial network, NTN, underlying embodiments of the present invention;

FIG. 32 shows an exemplary representation of considerations relating to embodiments of the present invention;

FIG. 33 shows a schematic illustration of a wireless communication scenario in accordance with embodiments, especially but not limited to the second aspect of the invention; and

FIG. 34 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals or namings even if occurring in different figures.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

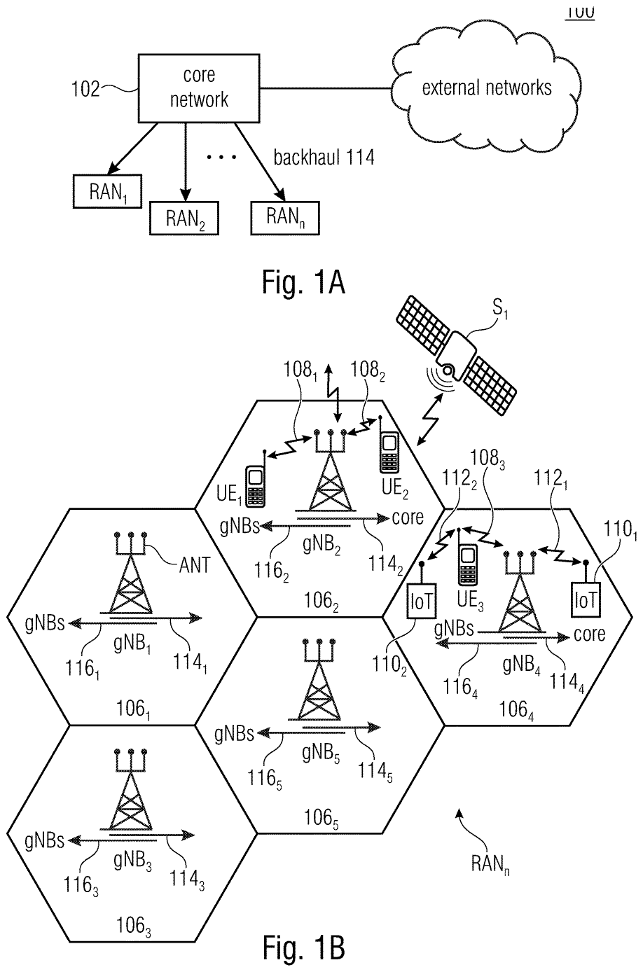

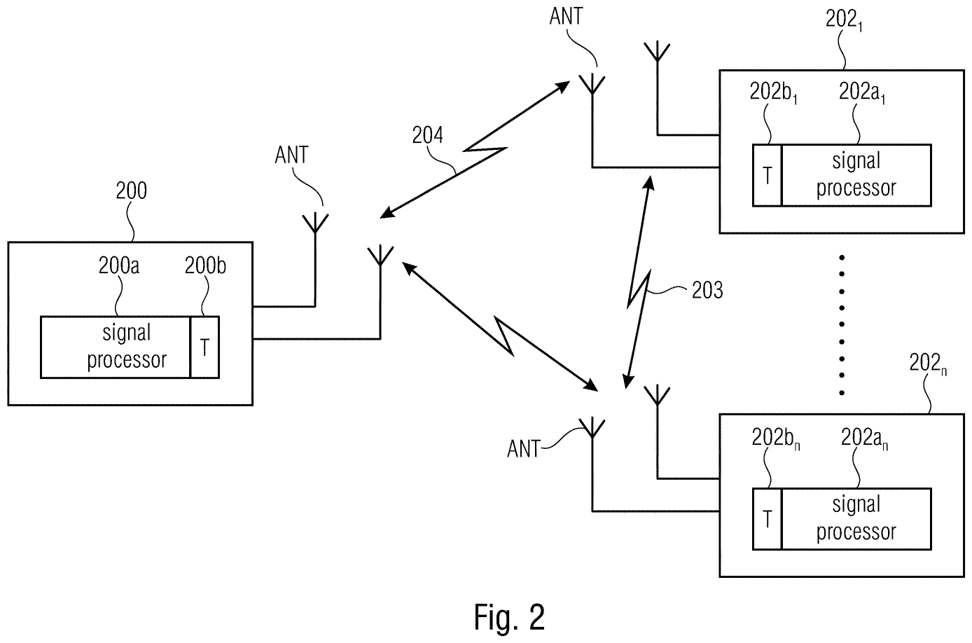

Embodiments of the present invention may be implemented in a wireless communication system or network as depicted in FIG. 1 including a transceiver, like a base station, gNB, or relay, and a plurality of communication devices, like user equipment's, UEs. FIG. 2 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

In niche or longtail applications—for example, Industrial IoT (IIoT)—that have specific requirements for Ultra Reliable and Low Latency Communication (URLLC) in combination with low-, medium- or high-data rates, the DSP design space requirements easily exceed those of a unified standard set of parameters. A standardized mechanism is thus need to embed domain and application specific DSP requirements for longtail application. To facilitate a DSP alternative on a wireless link between at least two nodes, the transmitter and receiver pair have to be provided with means to be DSP configurable on-demand. This includes without limitation the download of DSP modules and/or code together with their installation, configuration, activation, synchronization and the open-loop or closed-loop control of such DSP modules. These software modules have to be embedded on low PHY or mid PHY in order to provide the required wireless link enhancements needed for longtail applications. Furthermore, the facilitating scheme proposed by the inventors should allow to embed and use DSP modules which fit into the given standardized and regulatory framework, while being in detail implementation specific and therefore quasi proprietary.

The present disclosure provides a first aspect and a second aspect of improving wireless communications.

### Aspect 1: Coexistence Scenarios and Interference Management

In connection with the first aspect, there is first described the problem set to be solved. For doing so, an introduction of radio frequency spectrum allocation is provided, and then a generic problem definition is set out before detailing several specific problems. The latter are developed to later define a set of accompanying or associated solution proposals. Whilst the problem and solution set is based on the examples given, it is important to note that they present problem types which could be described by other specific examples. In this sense, the set of specific examples is used to provide a more general relationship between known or expected problems and their solution.

### Radio Frequency Spectrum Allocation

The radio frequency spectrum is a critical resource for a wide array of communication and broadcasting services, encompassing everything from radio and television broadcasting to mobile communications, satellite services, and various other applications. The spectrum is a finite and valuable resource, subject to careful allocation and regulation to ensure efficient and equitable use.

The allocation of the radio frequency spectrum is overseen by regulatory bodies such as the Federal Communications Commission (FCC) in the United States, the European Conference of Postal and Telecommunications Administrations (CEPT) in Europe, and similar organizations in other regions. These bodies manage the spectrum by dividing it into frequency bands, each designated for specific uses and services.

Spectrum allocation is typically based on a combination of international agreements and national regulations. International agreements, such as those established by the International Telecommunication Union (ITU), provide a framework for the global harmonization of spectrum use, ensuring consistency and compatibility across borders. National regulations then further refine the allocation of spectrum within a given country, considering local needs and circumstances.

The allocation of the spectrum is tailored to accommodate the diverse range of services and users. For instance, certain frequency bands are allocated for terrestrial broadcasting, including AM and FM radio, as well as television broadcasting. Other bands are designated for mobile communications, including cellular networks and wireless broadband services. Satellite services have their own designated bands, as do critical services such as aviation, maritime, and public safety communications.

Regulation of the radio frequency spectrum is essential to manage interference, ensure fair access, and promote efficient use. Regulatory bodies enforce rules governing spectrum use, including technical standards, power limits, and licensing requirements. These regulations help prevent interference between different services and users, safeguarding the integrity of communication networks and services.

Regional variations in spectrum allocation and regulation exist due to differences in national policies, technology adoption, and the specific needs of each region. For example, some regions may prioritize certain services over others, leading to variations in the allocation of spectrum bands. Additionally, regulatory frameworks and enforcement mechanisms can differ, influencing how spectrum is managed and utilized in different regions.

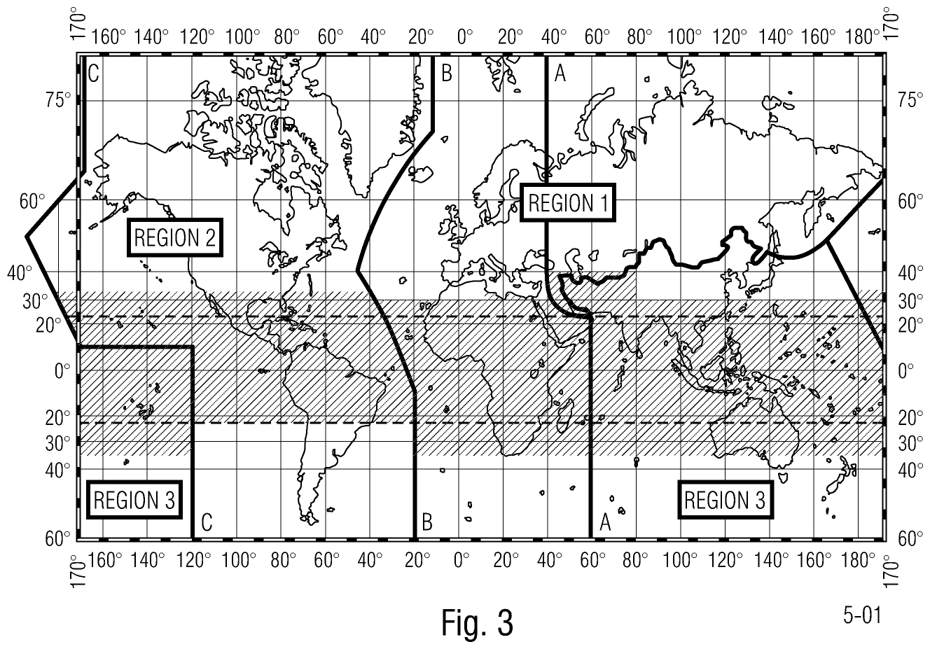

Radio frequency spectrum used for both terrestrial and non-terrestrial (space) applications is allocated by the International Telecommunications Union (ITU). The current radio regulations, dated 2020, will be revised in 2024 following the outcome of the World Radio Congress held in Dubai in 2023 (WRC-23). For the allocation of frequencies, the world has been divided into three Regions as shown in FIG. 3, i.e., there is shown a world map showing the three Regions defined by the ITU.

It should be noted that the words “regions” or “regional”, which are without a capital “R”, do not necessarily relate to the three Regions defined for purposes of frequency allocation. However, the following regional definitions may apply:
Region 1—Arab States, Africa, Europe, Commonwealth of Independent States
Region 2—Americas
Region 3—Asia-Pacific

The assignment of specific parts of the radio frequency spectrum to distinct services, applications, and use cases is a fundamental practice rooted in the principles of efficient spectrum management, technical considerations, and the need to mitigate interference. These allocations are informed by a range of factors, including the unique propagation characteristics of different frequency bands, the requirements of various services and applications, and the imperative to maintain interference-free communication environments.

In summary, the assignment of specific parts of the radio frequency spectrum to discrete services, applications, and use cases is underpinned by a consideration of propagation effects and the imperative to manage interference. By aligning frequency allocations with propagation characteristics and implementing measures to mitigate interference, regulatory bodies can optimize spectrum utilization, facilitate the delivery of diverse communication services, and cultivate an environment conducive to reliable and interference-free wireless communication.

### Spectrum and Radiowave Propagation

Propagation effects play a pivotal role in the allocation of the radio frequency spectrum. Different frequency bands exhibit diverse propagation characteristics, influencing their suitability for specific applications and services. For instance, lower frequency bands, such as those used for AM radio and long-wave communications, possess superior propagation capabilities, allowing signals to travel longer distances and penetrate obstacles more effectively. On the other hand, higher frequency bands, like those utilized for cellular networks and Wi-Fi, have shorter propagation ranges and are more susceptible to attenuation and obstruction from physical barriers.

These propagation effects necessitate the allocation of suitable frequency bands for particular use cases. For example, the use of lower frequency bands for long-range communications and broadcasting services, while higher frequency bands are reserved for short-range wireless applications. By aligning frequency allocations with propagation characteristics, regulatory bodies can optimize spectrum use, enhance coverage, and ensure the effective delivery of diverse communication services.

In connection with this recognition, the following problems are identified:

### Problem 1:

Interference is a significant concern in the realm of spectrum management and allocation. Interference occurs when signals from one communication system disrupt or degrade the performance of another system operating in the same frequency band or in nearby bands. This interference can result from a variety of sources, including adjacent-channel interference, co-channel interference, and out-of-band emissions.

### Problem 2:

The radio frequency spectrum is a vital resource that requires careful allocation and regulation to accommodate the diverse range of communication and broadcasting services, such careful allocation being not a straight-forward solution. International agreements, national regulations, and regional variations all play a role in shaping the allocation and management of the spectrum, with the overarching goal of ensuring efficient, equitable, and interference-free use by a multitude of services and users.

Embodiments provide for a solution for the need to improve communication, e.g., relating to problems identified herein. For example,

The allocation of specific frequency bands to distinct services and applications serves to mitigate interference. By assigning dedicated frequency bands to different services, the risk of interference between disparate systems is reduced, fostering a more harmonious and interference-free spectrum environment. Moreover, the establishment of technical standards, power limits, and emission masks further contributes to interference mitigation, ensuring that communication systems operate within defined parameters to minimize the potential for mutual interference.

A method, e.g., implemented by a resource allocating device such as a basestation, may comprise to allocate resources such as frequency bands to distinct services and/or applications.

### Frequency Reuse in Cellular Systems

Cellular communication systems reuse spectrum across the area and to provide continuous connectivity within the same frequency band for users under mobility. 4G and 5G systems are usually operated with full frequency reuse, meaning that neighbouring macro cells are simultaneously using the same spectrum band for transmission and reception.

In connection with this recognition, the following problems are identified:

### Problem 3:

At overlapping coverage footprints of cells this will cause inter-cell interference.

### Solution

With regard to overlapping footprints but not limited hereto, embodiments are related to the inter-cell interference and to handle such interference by means of interference coordination or cooperation on different PHY levels (L1, L2, L3) which may be supported by reference signals specifically associated with individual cells to measure and report observed interference. That is, according to embodiments, a device, e.g., a UE and/or a basestation may use reference signals for signalling purpose and/or for interference measurements that are associated with a specific cell, e.g., the cell operated by the device, the cell in which the device operates or a neighbouring cell suffering or causing interference.

### Problem 4:

When neighbouring cells operate at a footprint of significant different size, for example small cells embedded in a coverage footprint of a macro cell, then the associated imbalance in transmit power and the resulting size of the coverage footprint will cause significant cell footprint shrinkage of the small cells.

### Solution

With regard to footprints of different sizes embodiments may use additional technical means to manage interference and provide safe-modes to operate the small cells at a reasonable cell size, among which Almost Blank Subframes (ABS), and other features provided by the enhanced inter-cell interference coordination (eICIC) should be mentioned.

### Interference Management

The existing interference management schemes are designed to be used within the spectrum owned and operated by the same operator (MNO).

In case of adjacent bands causing inter-band interference, known or state-of-the art, SOTA, means of satisfying coexistence requirements include e.g. ACLR to reduced inter-band-inter-cell interference in downlink (DL) but also in uplink (UL).

In connection with this recognition, the following problems are identified:

### Problem 5:

Although a radio-frequency (RF) front-end design implemented in the receiver circuitry of basestation and user equipment will include filtering (e.g., cavity filters, bulk acoustic wave filters and surface acoustic wave filters), this will be for the entire bandwidth of the operating band in the case of TDD or of the uplink and downlink parts of the operating band in the case of FDD. In other words, the RF front-end does not include filtering around the carriers used within the band and the absence of such RF carrier filtering necessitates the need to fulfil adjacent-channel-leakage ratio (ACLR) requirements in the digital domain. However, this can prove to be insufficient when adjacent base stations operate in inverse direction mode (i.e., one basestation receives weak signals from distant users while the other simultaneously transmits at high power in an adjacent band).

### Problem 6:

The increasing demand of spectrum due to the ever-increasing hunger for more capacity in all communication systems causes the available spectrum to experience increasing scarcity and as a result reuse of spectrum across different systems and more flexible usage of adjacent bands and/or in overlapping coverage footprints has been identified as a necessary step forward for further efficient use of available spectral resources. To accomplish such ambitious goals not only requires inter-system and/or inter-operator interference management but also that this must or at least should be defined in a standardized way to satisfy the inter-system co-existence requirements.

### Solution

Adjacent bands may be operated with aligned slot structures providing that the RATs or services in the adjacent bands are similar or identical. For example, these could be: operated by: MNO1 and MNO2; or a public network and a non-public network (campus or private network). In practice this means that MNOs operate their services using carriers allocated in the same band, for example C-band. The use of synchronized frames with identical or compatible slot structures, reduces inter-band interference and in particular, cross link interference (CLI)—the latter is typically prevalent when adjacent bands are operated with different or incompatible TDD slot structures.

In the case of problem 5, dedicated analogue spectral filters at the transmitter and/or receiver can help to reduce the inter-band power leakage. Furthermore, spatial filtering (beam forming), at the transmitter and/or receiver can reduce the effective residual interference. As described herein, both interference reduction and mitigation techniques can not only be applied in combination but also together with further interference mitigation/handling/management techniques, for example eICIC.

Furthermore, if different communication systems are operated in spectral proximity or reuse (overlapping uplink or downlink footprint), the utilization of the same spectrum is usually subject to very strict protection mechanisms that endeavour to assure mutual coexistence. Classical examples are co-use of spectrum between: satellite and terrestrial systems; railway and public networks; GPS and terrestrial services; or military and public network operation (e.g. CBRS in the US).

Further Explanations of Terms Used in Connection with Interference Mechanisms According to the Invention

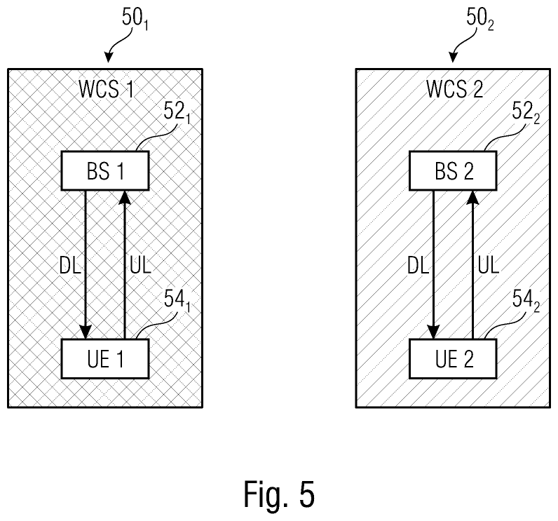

FIG. 5 shows two wireless communication systems 50₁ and 50₂. In each scenario, a wireless communication system (WCS) 50₁ and 50₂ is formed by at least a basestation (BS) 52₁, 52₂ respectively and a user equipment (UE) 54₁, 54₂ respectively which establish a communication link using uplink (UL) and downlink (DL) channels. At least one of the base stations 52 may be in accordance with a base station of FIG. 1 and/or at least one UE 54 may be in accordance with a UE described in connection with FIG. 1. The following configurations should be considered:
a WCS 52₁ and/or 52₂ may use the same (relevant for the first aspect) or different (relevant for the second aspect) radio access technology (RAT) as another WCS 52₂ and/or 52₁;
a WCS 52₁ and/or 52₂ may use frequency division duplexing (FDD); such a concept is also addressed in the second aspect of the present disclosure;
a WCS 52₁ and/or 52₂ may use time division duplexing (TDD); which is particularly relevant to the first aspect of the present disclosure;
a WCS 52₁ and/or 52₂ may use a hybrid combination of FDD and TDD; →in particular relevant to the first aspect of the present disclosure
a WCS 52₁ and/or 52₂ may use an FDD scheme that is similar or different to another WCS; which may relate to the second aspect of the present disclosure
a WCS 52₁ and/or 52₂ may use a TDD scheme that is similar or different to another WCS; which may relate to the first aspect of the present disclosure;
a WCS 52₁ and/or 52₂ may use a hybrid scheme that is similar or different to another WCS; which may relate to the first aspect of the present disclosure; and
a WCS 52₁ and/or 52₂ may be operated by the same or a different mobile network operator (MNO) as another WCS; which may be relevant for the first aspect of the present disclosure.

It should be noted that although the figure shows only two WCSs, there could be more than two WCSs that operate or are intended/designed to provide coverage in the same or different overlapping geographical coverage footprint, e.g., at least three, at least four or even higher numbers. Such coverage footprints shall include indoor coverage scenarios, outdoor coverage scenarios and hybrid combinations of both indoor and outdoor coverage scenarios.

It should be further noted that although each WCS shows only one BS and only one UE, a WCS may have more than one BS and may also have more than one UE. Further, a WCS may not be limited to have only BS and UEs but may also incorporate, use or operate further devise such as relays, reconfigurable intelligent surfaces, and so on. Moreover, whilst two WCSs are shown and in extension to the previous note, the number of BSs in the two or more WCSs may be equal or different in number. Furthermore, the BSs of the two WCS can be deployed at the same locations (co-site deployment or site sharing) or on different locations (non-co-site deployment). Furthermore, the number of UEs in the two or more WCSs may be equal or different in number.

In connection with this recognition, the following problem is identified:

### Problem 7:

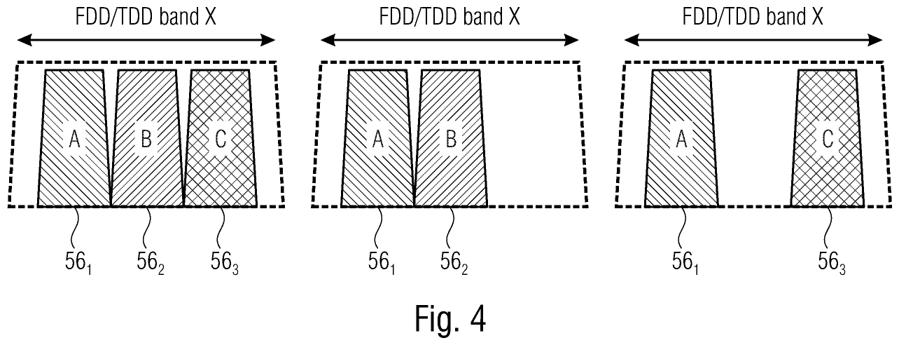

In general, an MNO may reuse an allocated carrier 56₁, 56₂ and/or 56₃ or a higher number of carriers. For example carrier 56₁ “A” from FIG. 4 may result in an intra-carrier interference experienced between devices/entities of neighbouring cells (WCS).
Furthermore, adjacent carriers, e.g. carrier A and carrier B, i.e., carrier 56₁ and 56₂ in FIG. 4 may be operated by the same MNO which may allow for carrier aggregation or may be operated by different MNOs, e.g. MNO_A and MNO_B resulting in inter-carrier interference experienced between devices/entities of neighbouring carriers of the same MNO or different MNOs. It is noted that this is to be understood again within the transmission range and therefore coverage footprint of the devices belonging to the two WCSs.

When referring now to the scenarios described herein it is to be noted that in connection with embodiments described herein the terms cross-carrier and inter-carrier are used as synonyms.

It may be observed that while a WCS is shown, e.g., in FIG. 5 to comprise one or more base stations, these can be the same or different type of equipment used in a WCS, may be the same or different vendor providing infrastructure equipment to the WCS or MNO.

Referring now to FIG. 4, there are shown illustration examples of spectrum of a frequency band, band X, operated in FDD or TDD mode wherein parts are allocated to carriers (a part of the frequency band) as carriers 56 with a particular system bandwidth e.g. 20 MHz in 4G-LTE or 100 MHz in 5G-NR. Such carriers can be operated simultaneously as adjacent carriers, A&B (contiguous spectrum allocation) or with frequency gaps in-between, A&C (non-contiguous spectrum allocation). Furthermore, if carriers in the same band are operated by one of the WCS together it will be referred to as carrier aggregation. If the different carriers of the same band are allocated to different MNOs or e.g. a campus networks (carrier A) and public network (carrier B) then the scenario may be referred to as a multi-operator or multi-MNO scenario.

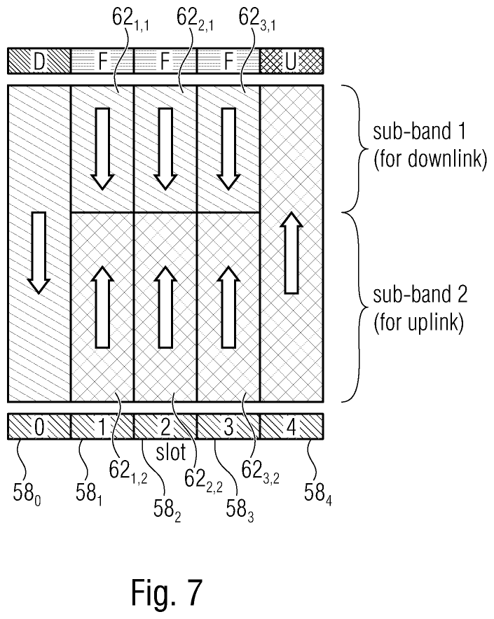

Referring now to FIG. 5, the scenario illustrated may be used to consider the effects of interference from one WCS to another WCS. For doing so, reference is made to FIG. 7 showing an illustration of several interference mechanisms labelled a-h affecting two wireless communication systems 50₁ and 50₂. The interference situations depicted can be applied for intra-carrier scenarios and inter-carrier scenarios according to FIG. 4. One or more of the following interference may occur:
a) Cross-link interference. WCS 1→WCS 2. BS 1 (DL)→BS 2 (UL)
b) Inter-cell interference. WCS 1≥WCS 2. BS 1 (DL)→UE 2 (DL)
c) Inter-cell interference. WCS 1→WCS 2. UE 1 (UL)→BS 2 (UL)
d) Cross-link interference. WCS 1→WCS 2. UE 1 (UL)→UE 2 (DL)
e) Cross-link interference. WCS 2→WCS 1. BS 2 (DL)→BS 1 (UL)
f) Inter-cell interference. WCS 2→WCS 1. BS 2 (DL)→UE 1 (DL)
g) Inter-cell interference. WCS 2→WCS 1. UE 2 (UL)→BS 1 (UL)
h) Cross-link interference. WCS 2→WCS 1. UE 2 (UL)→UE 1 (DL)

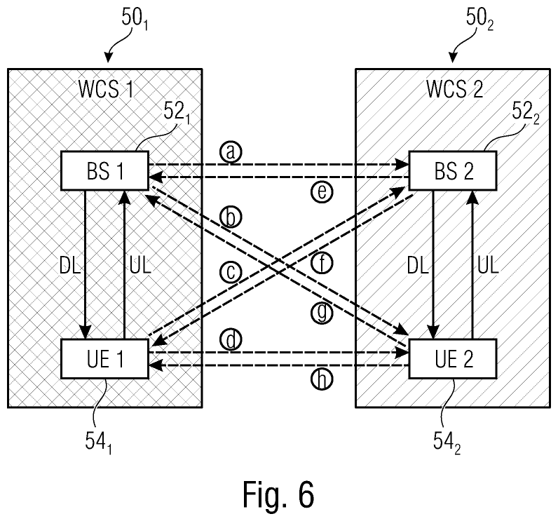

The terms cross-link interference (CLI) and inter-cell interference (ICI) are to differentiate the kind of co-channel interference (CCI), wherein in ICI: a UE receiver experiences interference from another BS; or a BS receiver experiences interfering signals from UEs served by a different BS. CLI describes the fact that a UE receiver experiences interference coming from a UE transmitting to a BS while the victim UE is receiving signals from its serving BS. A similar interference scenario is when a BS receiver is interfered by a BS transmitting in downlink which causes severe interference for the UL signals from a UE served by the victim BS. Furthermore, it should be noted that ICI and CLI can be intra-band, inter-band or any combination thereof. In the context of the invention disclosed herein, the combinations of WCS1 & WCS2 in FIG. 6 and the associated carriers A and/or B from FIG. 4 illustrate the importance to differentiating the different scenarios and how the proposed solutions apply to them. This is described by way of four example use cases (1a, 1b, 2a and 2b).

USE CASE 1: When WCS1 and WCS2 are operated on the same carrier frequency—for example carrier A, B or C-then the resulting co-channel interference (ICI and CLI) will be referred to as intra-carrier interference and is measurable by the same means as used for operating the wireless link within WCS1. In this context, “same means” refers to signal processing operated on the same carrier frequency and usually with same or similar system parameters. To elaborate further, we consider the following:
USE CASE 1a: WCS1 and WCS2 are operated by the same MNO and provide the same service over a larger area including mobility. Here, the co-channel interference is managed by one MNO whose interest is to ensure smooth and flexible operations of WCS1 and WCS2—in most cases, these will be neighbouring base stations with overlapping coverage footprints.
USE CASE 1b: WCS1 and WCS2 are operated by different MNOs that provide different services within an overlapping coverage footprint—for example, two private or campus or non-public networks operated by two factories which share the same building or campus. Here, the co-channel interference cannot be treated within a single MNO and successful interference management is of interest to the two different MNOs to ensure smooth and flexible operations of WCS1 and WCS2. Therefore, both intra-carrier and inter-MNO interference coordination is required.

Solution 1: As mentioned above, according to use case 1a, to handle the co-channel interference, one MNO could manage the co-channel interference. According to such embodiments, devices and methods are provided that measure co-channel interference and adapt usage of the resources to mitigate such the interference. Thereby, for example, the problems mentioned above may be addressed.

Solution 2: As mentioned above, according to use case 1b, to it is of advantage to provide for intra-carrier interference coordination and inter-MNO interference coordination. According to such embodiments, devices and methods are provided that measure co-channel interference and adapt usage of the resources to mitigate such the interference. Thereby, for example, problems mentioned above may be addressed.

USE CASE 2: When WCS1 and WCS2 are operated on different carrier frequencies—for example carrier A&B or A&C, then the resulting co-channel interference (ICI and CLI) will be referred to as inter-carrier interference and can usually be treated by coordination across carriers—thus necessitating inter-carrier interference coordination. Accurate and direct interference measurements may be required to be made by the carrier causing the interference. If this is not possible, then interference assessment can be done implicitly by observing the impact on sensitivity and receive power levels (in particular slots or OFDM symbols) due to the fact that frequency specific interference measurements have to be performed at the bands or bandwidth part (BWPs) which are causing the interference while the WCS in question is operating at a different carrier frequency. To elaborate further, we consider the following:
USE CASE 2a: WCS1 and WCS2 are operated by the same MNO and are used in carrier aggregation mode to allow higher throughput for UEs or at least for a particular base station. The inter-carrier interference therefore can be treated within one MNO. Since it is an intrinsic interest of the MNO to ensure smooth and flexible operations of Carrier A and Carrier_B—in most cases these will be the same and neighbouring base stations with overlapping coverage footprints. In this use case, cross-carrier measurements and cross-carrier scheduling can be used by the base station as mechanisms to assess and handle cross-carrier interference.
USE CASE 2b: WCS1 and WCS2 are operated by different MNOs which prefer to have independent usage of uplink and downlink configurations including TDD slot structures. Inter-carrier interference cannot therefore be treated within one MNO which necessitates the means for inter-MNO and inter-carrier coordination. Since MNOs usually prefer a high degree of independence for flexible operations of their carriers (A or B), any deviation from a fully synced frame and pure TDD slot structures will cause inter-carrier interference for devices and entities belonging to the two WCSs regardless of whether their deployment is co-sited or non-co-sited.

Solution 3: As mentioned above, according to use case 2a, to handle the inter-carrier interference can be treated within one MNO.

Solution 4: As mentioned above, according to use case 2b, to it is of advantage to provide to an inter-MNO coordination to coordinate the slot synchronization.

Traditional system design has to date not focused on inter-carrier measurements for the bands of different MNOs and hence limited means have been developed within the standardization framework.

Solution 5: Embodiments described herein provide solutions for effective inter-carrier interference measurements, reporting and use thereof for inter-carrier interference mitigation techniques to be applied by each MNO individually and independently and further or as an alternative inter-carrier interference mitigation techniques which exploit inter-carrier coordination across MNOs.

Use case 2b is of particular importance as an enabler for other use cases according to embodiments. This includes flexible TDD operation which although having been defined in 3GPP, is thus far unsuitable for deployment as the means to measure and handle inter-carrier interference effectively and efficiently are lacking. Furthermore, other scenarios which include adjacent of nearby bands are operated by WCSs using different RATs or different numerologies of the same RAT and inter-carrier interference is expected or observed in at least parts of the coverage footprint of at least one of the WCSs.

### Flexible Duplex and Sub-Band Full Duplex

As depicted in FIG. 4 the case of co-allocation of the same, overlapping or adjacent (nearby) spectrum within the same band used for a WCS operated by the same or a different MNO will cause inter-WCS co-channel interference in overlapping coverage footprints and therefore may be required to be handled by the appropriate means.

Assuming that carrier frequency A of carrier 56₁ and carrier frequency B of carrier 56₂ are licensed to and operated by the same or associated operators and furthermore the two systems (WCS) use the same technology—for example, 4G-LTE or 5G—NR-then the co-existence problem may be addressed and handled by using existing techniques together with additional novel techniques proposed by embodiments described herein. Some scenarios may require the enhancement of existing techniques, novel solution components or combinations thereof.

### Solution 7:

These novel techniques addressing and solving one or several of the above problem sets include the following solutions that may be implemented individually, groupwise or in combination:
Interference measurement means including reference signals (RS) and dedicated time frequency resources for inter-system (inter-WCS) interference measurements.
Reporting mechanisms for intra-system intercell interference measured in DL or UL (applies to intra-carrier and inter-carrier interference).
Reporting mechanisms for inter-system (inter-WCS) crosslink interference (CLI) experienced by:
   UEs of a 1^{st} WCS such as UE 54₁ of WCS 50₁ receiving in DL caused by UEs of the 2^{nd} WCS such as UE 54₁ of WCS 50₂ simultaneously transmitting in UL or by;
   Basestations of a 1^{st} WCS such as BS 52₁ of WCS 50₁ receiving in UL caused by basestations of the 2^{nd} WCS such as BS 52₂ of WCS 50₂ simultaneously transmitting in DL
   both CLI scenarios apply to intra-carrier and inter-carrier interference.
Reporting mechanisms for inter-system intercell interference experienced by:
   UEs of a 1^{st} WCS such as UE 54₁ of WCS 50₁ receiving interference in DL caused by base station of the 2^{nd} WCS such as BS 52₂ of WCS 50₂ simultaneously transmitting in the DL or by
   basestations of a 1^{st} WCS such as BS 52₁ of WCS 50₁ receiving interference in UL caused by UEs of the 2^{nd} WCS such as UE 54₂ of WCS 50₂ simultaneously transmitting in UL
   both ICI scenarios apply to intra-carrier and inter-carrier interference.
Reporting mechanisms for inter-system (inter-WCS) crosslink interference (CLI) from its measurement entities, either base stations or UEs (applies to intra-carrier and inter-carrier interference).
Inter-system (inter-WCS) coordination channels and associated protocols. The meaning of inter-system in this context includes but is not limited to: inter-RAT; inter-MNO; between cells or different TDD slot structures; and between cells of different sub-band full duplex configurations (SBFD) (applies to all intra-carrier and inter-carrier interference scenarios and combinations thereof).
eICIC extensions dedicated to inter-system (inter-WCS) interference (co-deployment of TDD and FDD operation), beyond SOTA, which is intra-carrier, intra-MNO (usually) and inter-cell, e.g. macro-picocell coordination.

It is noted, that any measurement by devices or entities of a 1^{st} WCS based on signals coming from a 2^{nd} WCS and causing interference to the receiver belonging to a 1^{st} WCS, may require or may use at least partial knowledge about the system configuration of the aggressor (2^{nd} WCS), i.e., the source of interference. In the absence of such (partial) knowledge, interference assessment at any receiver of the 1^{st} WCS may be mainly restricted to implicit interference measurements—for example, interference measurement on muted resources or observation of receive power levels (RSSI) and correlation with knowledge about RRM configuration of the 1^{st} WCS (e.g. power spectral density distribution, transmit power, beamforming applied, slot or RE (resource element) blanking/muting, reference signal boosting (RS-boosting), etc). If further system information about the aggressor system (2^{nd} WCS) is available, more accurate interference assessment can be performed, e.g. RSRP measurements based on system information about reference signals used by the aggressor-WCS.

### Solution 8:

In the case of different MNOs, e.g. a 1^{st} MNO operating a 1^{st} WCS such as WCS 50₁ and a 2^{nd} MNO operating a 2nd WCS such as WCS 50₂, embodiments provide for an inter-MNO system information exchange that is very beneficial and furthermore embodiments provide novel measurement configurations on the carrier operated by the other MNO.

According to embodiments, interference measurements for a part of a solution described herein and may serve, e.g., as a necessary or at least helpful input, for appropriate measures solve the problem to manage or mitigate the inter-system (inter-WCS) interference, see, e.g., problem 7.

Assuming appropriate and sufficient interference measurement data can be collected by receivers operating in accordance with embodiments and experiencing, observing and measuring the interference and providing reports containing raw data or pre-processed interference information, then the affected WCS can approach the interference handling by applying two mayor categories of means:

1. Interference Mitigation Techniques Independent from the Other WCS (Aggressor)

A classic example would be the DL case where the 1^{st} and the 2^{nd} WCS operate with a different TDD slot structure. Furthermore, as a result from the measurements provided by a multitude of UEs of the 1^{st} WCS it can be concluded that at least:
not all UEs of the 1^{st} WCS experience significant interference from the 2^{nd} WCS,
not all DL time resources (e.g. DL slots, frames, symbols) used by the 1^{st} WCS experience significant interference from the 2^{nd} WCS,
not all DL frequency resources (e.g. carriers, DL BWPs or DL spectral resources) used by the 1^{st} WCS experience significant interference from the 2^{nd} WCS,
not all DL channels (e.g. user plane (UP) or control plane (CP) channels) used by the 1^{st} WCS experience significant interference from the 2^{nd} WCS,

Given such insights or conclusions from the interference measurements and reports the 1^{st} WCS can:
schedule any UE on “unaffected” or “moderately affected” radio resources (e.g. DL slots which are simultaneously operated by a 1^{st} WCS and a 2^{nd} WCS).
“unaffected” or “moderately affected” UEs (e.g. a UE which is indoors and therefore better isolated from an interfering base station outdoors) or groups thereof onto any radio resources available to a 1^{st} WCS which have been identified due to the individual UE report, to be suitable for DL use.
schedule system information or user specific information e.g. CORESETs or other control channels into radio resources which are “unaffected” or “moderately affected” by the interference from a 2^{nd} WCS.
at least one of the WCSs observes and learns patterns or behaviour and its associated interference impact onto at least one of its devices or entities and predicts future availability or resources or interference impact onto at least one of its devices or entities and applies appropriate radio resources allocation or user scheduling strategies to mitigate expected interference impacts.

It is noted that such an adaptation of use of radio resources based on measurements collected from receivers of a 1^{st} WCS are of advantage especially in case if the interference situation remains constant or quasi-static over relevant resource allocation and scheduling periods. In case of temporal variations of the experienced interference coming from a 2^{nd} WCS by UEs of the 1^{st} WCS or onto radio resources to be concluded to be suitably safe to use by a 1^{st} wCS, then:
the measurements of the 1^{st} WCS may or should be updated more frequently,
statistical interference mitigation techniques can be applied (e.g. frequency hopping, coding over longer periods, repetition coding, low MCS modes, etc.),
interference pattern identification and prediction methods cab be applied,
a priori knowledge about future interference scenarios on radio resources or about UEs can be applied-one way is through interference coordination by e.g. beam coordination or coordinated patterns of radio resources between the 1^{st} WCS and the 2_{nd} WCS.
   2. Interference Mitigation Techniques in Coordination with the Other WCS (Aggressor)

Again, an example would be the DL case where the 1^{st} and the 2^{nd} WCS operate with a different TDD slot structure. Furthermore, as a result from the measurements provided by a multitude of UEs of the 1^{st} WCS it can be concluded that at least:
many or a dominant number UEs of the 1^{st} WCS experience significant interference from the 2^{nd} WCS on most or all radio resources available to the 1^{st} WCS (no safe radio resources to serve many users),
particular DL time resources (e.g. DL slots, frames, symbols) used by the 1^{st} WCS e.g. SSBs experience significant interference from the 2^{nd} WCS OR many thereof (insufficient number of time resources considered to be safe-guarded),
particular DL frequency resources (e.g. carriers, DL BWPs or DL spectral resources) used by the 1^{st} WCS, e.g. SSBs experience significant interference from the 2^{nd} WCS OR many thereof (insufficient number of time resources considered to be safe-guarded),
important/system relevant/system performance relevant DL channels (e.g. user plane (UP) or Control plane (CP) channels) used by the 1^{st} WCS experience significant interference from the 2^{nd} WCS,

Given such insights/conclusions from the interference measurements and reports the 1^{st} wcs indicates a strong need or benefit from:
radio resource coordination between a 1^{st} WCS and a 2^{nd} WCS.
   To safeguard certain radio resources for a 1^{st} WCS OR a 2^{nd} WCS
   By, for example:
      Applying semi-persistent radio resource allocations for TDD slot configurations, SBFD configurations, beam directions, beam allocation orders, power spectral densities, transmit power, muting or RE, BWPs, slots etc. (system information exchange between the two WCSs might be sufficient when done once, occasionally, request-based or event-based, when system information changes have been made).
      Exchange of future radio resource allocations between a 1^{st} WCS and a 2^{nd} WCS
      Aligned or coordinated behaviour (configurations) of a 1^{st} WCS and a 2^{nd} WCS allowing enough radio resources available for at least one of the two WCS OR sufficient number of UEs belonging to at least one WCS to be served reliably according to a targeted service level (QoS) or that particular WCS. To maintain balance between the two cooperating WCSs the preference can be shifted from one to the other or alternated between them.
At least one of the WCSs observes and learns patterns or behaviour and its associated interference impact onto at least one of its devices or entities and predicts future availability or resources or interference impact onto at least one of its devices or entities and applies appropriate radio resources allocation or user scheduling strategies to mitigate expected interference impacts. Based on the concluded radio resource availability and associated KPIs, e.g. coverage or capacity or a quality of service provided to its users, further coordination mechanisms can be evaluated regarding their effectiveness and efficiency and attempts to coordinate one or a set of these means with the other WCS.

It is noted that such adaptation of use of radio resources based on measurements collected from receivers of a 1^{st} WCS are of advantage especially in case if the interference situation remains constant or quasi-static over relevant resource allocation and scheduling periods. In case of temporal variations of the experienced interference coming from a 2^{nd} WCS by UEs of the 1ₛₜ WCS or onto radio resources to be concluded to be suitably safe to use by a 1^{st} WCS, then:
the measurements of the 1^{st} WCS may or should be updated more frequently,
statistical interference mitigation techniques can be applied (e.g. frequency hopping, coding over longer periods, repetition coding, low MCS modes, etc.),
interference pattern identification and prediction methods can be applied,
a priori knowledge about future interference scenarios on radio resources or about UEs can be applied—one way is through interference coordination by e.g. beam coordination or coordinated patterns of radio resources between the 1^{st} WCS and the 2^{nd} WCS.

### A Generic Problem Set

In general, at least a part of the related problem statement refers to the following use cases:
1. Solving co-existence between two different wireless communication systems operated in overlapping spectrum and with overlapping coverage footprint (e.g. NTN and TN co-deployment)
2. Solving co-existence between two similar (e.g. same numerology) wireless communication systems operated in overlapping spectrum and with overlapping coverage footprint (neighbour cells of same MNO and same spectrum operated with different slot structure)
3. Solving co-existence between two different wireless communication systems operated in adjacent spectrum and with overlapping coverage footprint. (e.g. Rail and public networks at 1900 MHz)
4. Solving co-existence between two similar (e.g. same numerology) wireless communication systems operated in adjacent spectrum and with overlapping coverage footprint (e.g. different MNOs using different slot structures, Flexible TDD or SBFD)

Whilst items 2 and 4 are at least mainly addressed by the first aspect of the present disclosure, items 1 and 3 are mainly addressed by the second aspect.

It is mentioned that a further side constraint may harden or relax the problem set to be solved which is the aim/target to minimize interdependencies between bands, which cause or suffer from intra-band, inter-band or inter-system interference. A classic example is given by two MNOs operating adjacent spectrum with certain TDD slot configurations which create interference coupling and therefore has performance impact on part or all the radio resources use by each MNO. A good solution should provide a sweet spot between rigid coordination configuration coordination long term and over large areas, e.g. like today's synced TDD slot structures and flexibility in achieving a e.g. different UL/DL ratio used by the two MNOs. Such solutions allow independent scheduling and RRM decisions to be made by each MNOs subject to some reasonable effort on inter-MNO coordination.

A similar example can be a TN-MNO and an NTN-MNO using nearby/overlapping spectrum with overlapping footprint. Again, inter-system coordination should be kept reasonable while each system can operate with its radio resources according to well established/proven mechanisms. Such willingness to coordinate configurations is easier to be obtained if joint or complementing interests of the two MNOs in the given examples are given, e.g. partnerships between NT and NTN to fill coverage holes or boost capacity for users in co-deployment situations. While such mutually benefitting settings may become trailblazing for market introduction, mechanisms used to facilitate these use cases may become mandated or considered as standard means to handle interference of similar kind even for MNOs or systems which don't benefit explicitly or in a balanced way when inter-band or intersystem coexistence requirements are relaxed.

Referring now to FIG. 7 showing a schematic illustration of radio resource management, RRM, in a Sub Band Full Duplex, SBFD slot configuration having a plurality of slots 58₀ to 58₄, wherein the number of slots may be any different number corresponding to a frame or not, e.g., comprising a value of at least 1, at least 2, at least 3, at least 4, at least 8, at least 9, or more, e.g., 14. Some embodiments of the present disclosure are related to the following solution ideas:
Slot 58₀ (0) is a full downlink slot (D), and slot 58₄ (4) is a full uplink slot (U). In-between there are 3 slots 58₁, 58₂ and 58₃ configured as flexible slots (F), where, in a certain part of the spectrum, a 1^{st} sub-band 62_{1,2} with i representing the slot number 1, 2, 3 respectively, is configured to operate in UL mode and a 2^{nd} sub-band 62_{i,1} is configured to operate in DL mode.
Depending on the experienced cross-link interference (CLI) situation, a particular UE may be scheduled exclusively into slot 0 for DL reception, when it suffers from CLI (according to a threshold, a limit, a trigger) coming from another UE transmitting in UL in slots 1-3.
Furthermore, as an alternative or in addition according to an embodiment, a particular UE might be scheduled in slot 4 for exclusive UL transmission if the received UL signal at the gNB is significantly degraded by CLI received from another gNB.
UEs not experiencing significant CLI from other UEs can use the SBFD DL sub-band 62_{i,1} for DL reception.
On the other hand, UEs which have an UL transmission that is received sufficiently-well by the gNB, can be scheduled in the SBFD UL sub-band 62_{i,2} for UL transmission, providing additional resources.

It is noted, that by these mechanisms, UEs served in the SBFD slots do not have to support any full duplex capability (simultaneous transmission and reception). Therefore, the complexity can be confined at the gNB side, wherein SBFD capability can be implemented to improve flexibility in resource allocation between UL and DL by configuring flexible slots with a suitable sub-band design for UL and DL resources.

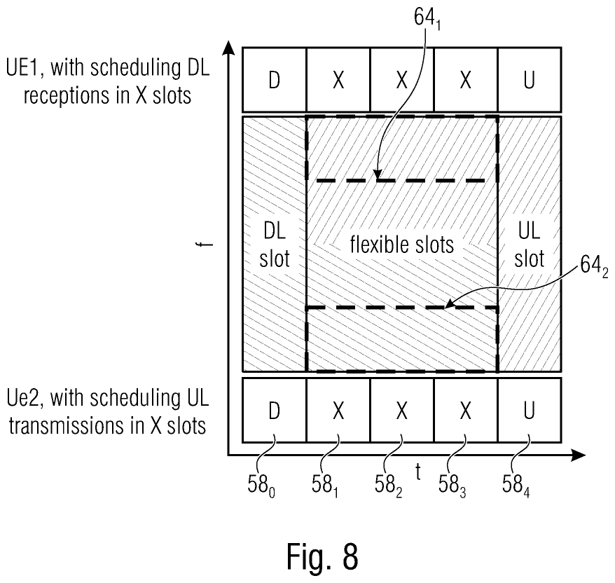

Referring now to FIG. 8 showing a more detailed illustration for scheduling UEs in slots 1-3 similar to FIG. 7. The following solution ideas are noted regarding two UEs:
The UEs can be scheduled for exclusive reception or transmission in different slots 58₀, 58₄ (labelled “D” and “U”). Such a concept is used in known (LTE/NR) TDD configurations.
The UEs can be scheduled for simultaneous reception and transmission in the same slots 58₁, 58₂ and 58₃ (labelled “X”). DL and UL are using allocated radio resources—UE1 in the red-lined dashed region at the bottom is in DL Rx mode and UE2 in the other red-lined dashed region at the top is in UL Tx mode.
UE1 does not experience significant levels of cross-link interference in the DL SBFD sub-band from UE2 scheduled in the UL SBFD sub-band.
L The gNB receiving the UL transmission from UE2 does not experience significant levels of cross-link interference in the UL SBFD sub-band from another gNB operating a DL SBFD sub-band in the slots labelled “X”.
This allows the gNB to support simultaneous UL reception and DL transmission. This allows for a more flexible resource grid that can cater for variable data rate and latency needs of the UEs served by the gNB.
Resources located between the two dashed regions 64₁ and 64₂ may be understood as an area where a flexible partitioning of the sub-bands allows UL and DL resources to be allocated according to needs.
Although dashed regions 64₁ and 64₂ have been shown in isolation and are not overlapping, this does not exclude the overlapping of DL and UL resources using flexible SBFD sub-band allocation or even within one or more OFDM symbols.

Although the example is presented for two UEs and two sub-bands only, it can be applied to more than two UEs and/or to more than two sub-bands. It should be noted that if a (future) UE is capable of full-duplex operation, then further degrees of scheduling for simultaneous reception and transmission in the same slot or OFDM symbol are possible or could be exploited.

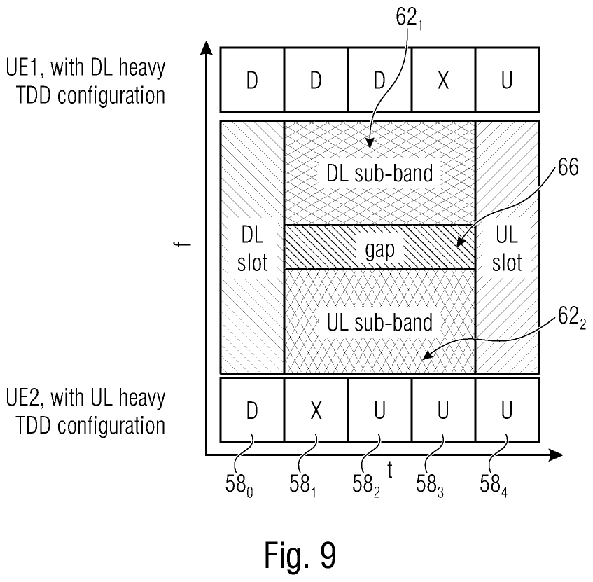

Reference is now made to FIG. 9 showing two UEs operate under heavy traffic conditions, similar to FIG. 8. The solution ideas presented in connection with FIG. 9, with two or more UEs operating under heavy traffic conditions, respectively:
UE1 may require more DL resources due to heavy DL traffic needs. Resources from the DL slot 58₀ and the DL SBFD sub-band 62₁ of one, more or all slots 58₁ to 58₃ may thus be assigned to UE1.
UE2 requires more UL resources due to heavy UL traffic needs. Resources from the UL slot 58₄ and the UL SBFD sub-band 62₂ of one, more or all slots 58₁ to 58₃ may thus be assigned to UE2.
A digital filter may be applied to the entire bandwidth of the DL/UL slot.
The DL and UL sub-bands are separated by a spectral gap 66.
The introduction of a gap 66 between the UL and DL sub-bands, will allow further digital filtering to be applied on a sub-band basis at both the transmitter (gNB DL SB filtering, UE UL SB filtering) and the receiver (gNB UL SB filtering, UE DL SB filtering). This decreases the level of cross-link interference which here can be identified as inter-sub-band interference.

Although the example is presented for one gNB, two UEs and two sub-bands, it can also be applied to more than one gNB, more than two UEs and/or to more than two sub-bands.

When different sub-band partitioning and/or different slot configurations are used by more than one gNB, then the cross-link interference can become more severe compared to using the same sub-band partitioning and the same slot configurations for multiple gNBs with overlapping coverage footprints.

It is noted that if a (future) UE is capable of full-duplex operation, then further degrees of scheduling for simultaneous reception and transmission in the same slot or OFDM symbol are possible or could be exploited.

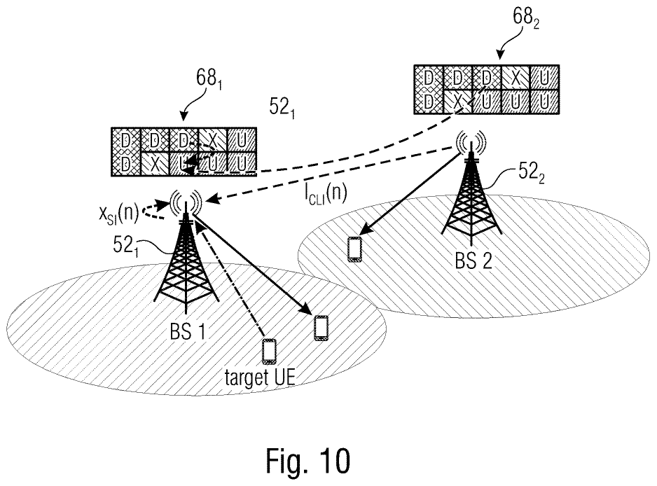

With reference to FIG. 10 showing an illustration of interference scenarios in a SBFD configuration when BS1 and BS2 are configured with identical SBFD frame structures 68₁, 68₂ the following solution ideas form embodiments of the present invention:
BS1 52₁ and BS2 52₂ are configured with identical SBFD frame structures.
BS1 52₁ may experience two types of interference:
   a first type of interference called self-interference, wherein the transmitted signal power from the DL sub-band of BS1 enters the uplink receive chain of BS1.
      According to embodiments, self-interference-cancellation (SIC) techniques are applied at BS1.
      [symbol] These can be implemented by using TX-RX antenna isolation or decoupling and further analogue and digital SIC means.
   a second type of interference called cross-link interference, wherein the transmitted signal power from the DL sub-band of BS2 52₂ enters the uplink receive chain of BS1 52₁.
      This can be mitigated by using spatial filtering (beamforming) at the transmitter of BS2 and at the receiver of BS1, whereby spatial nulls can be directed at one another.
      Such spatial nulling is particularly effective when the wireless channel (the propagation channel) between BS1 and BS2 is dominated by a line-of-sight, LOS, component.
      [symbol] Similar null forming techniques can also be applied one or more UE.
      Furthermore, sub-band specific filtering can be applied for the purpose of reducing CLI provided that basestations use compatible sub-band configurations.

Although the example is presented for two gNBs, three UEs and two sub-bands, it can also be applied to more than two gNBs, more than three UEs and/or to more than two sub-bands.

When different sub-band partitioning and/or different slot configurations are used by more than one gNB, then the cross-link interference can become more severe compared to using the same sub-band partitioning and the same slot configurations for multiple gNBs with overlapping coverage footprints.

It should be noted that if a (future) UE is capable of full-duplex operation, then further degrees of scheduling for simultaneous reception and transmission in the same slot or OFDM symbol are possible or could be exploited.

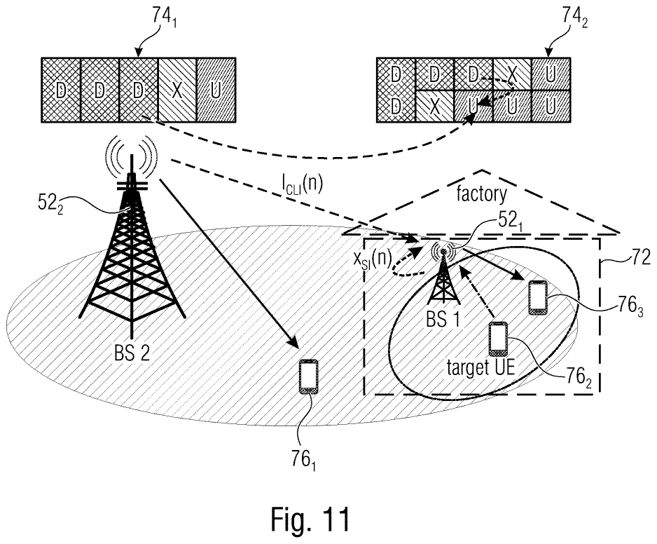

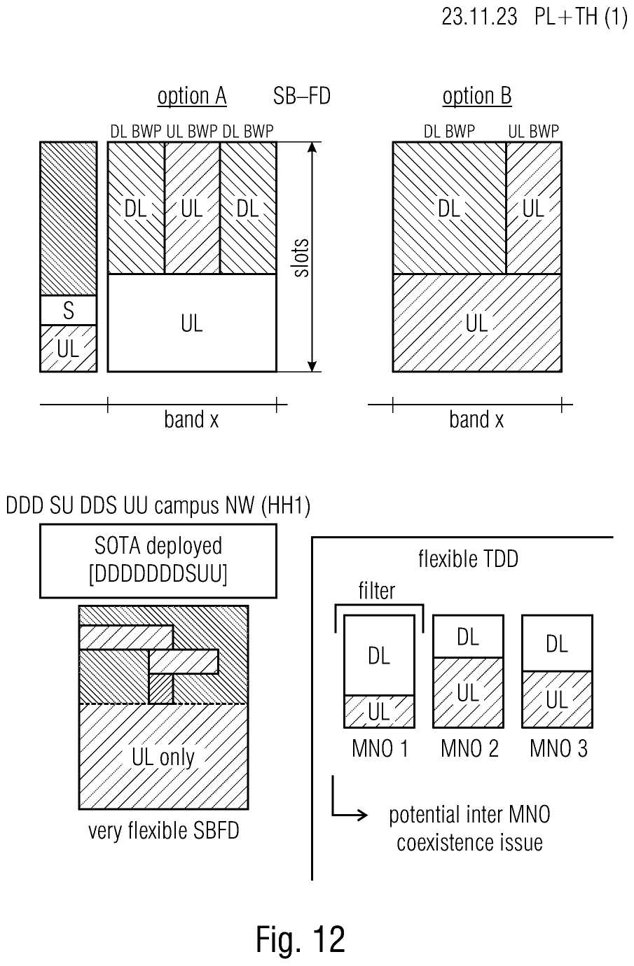

With reference to FIG. 11, the following solution ideas according to embodiments are noted:

FIG. 11 shows a schematic illustration of an outdoor-to-indoor cross-link interference scenario according to an embodiment.

BS2 52₂ may be a macro basestation and BS1 52₁ may be an indoor basestation. Typically but not necessary, such an indoor basestation operates with a lower transmitter output power than the macro basestation.

The indoor environment is contained within a building 72 such as—by way of non-limiting example—a factory, a hospital, an educational building or the like. Transmissions propagating from the outdoor to the indoor environments may experience building penetration losses which are typically of the order of 10-30 decibels.

Whilst the two BSs 52₁ and 52₂ use similar or compatible slot structures 74₁ and 74₂, only the indoor BS 52₂ uses SBFD sub-bands in the illustrated embodiment.

The outdoor UEs such as UE 76 are configured for classical TDD operation according to BS2 52₂. The indoor UEs 76₂ and 76₃ may be configured for SBFD operation according to BS1 52₁.

Indoor BS1 52₁ may experience, for example, two kind interference:
a first type of interference called self-interference, wherein the transmitted signal power from the DL band or sub-band of BS1 52₁ enters the uplink receive chain of BS1 52₁.
   This may be addressed by self-interference-cancellation (SIC) techniques to be applied at BS1 52₁.
   These techniques may be implemented by using TX-RX antenna isolation or decoupling and further analogue and digital SIC means.
a second type of interference called cross-link interference, wherein the transmitted signal power from the DL band of outdoor BS2 52₂ enters the uplink receive chain of indoor BS1 52₁.
   This can be mitigated by using spatial filtering (beamforming) at the transmitter of outdoor BS2 52₂ and at the receiver of indoor BS1 52₁, whereby spatial nulls can be directed at one another.
   Such spatial nulling becomes more challenging due to the outdoor-to-indoor propagation channel between BS2 52₂ and BS1 52₁.
   Similar null forming techniques can also be applied at the UEs served by BS1 52₁.
   Sub-band specific filtering is expected to be less effective when the basestations use incompatible spectral uplink/downlink configurations.

Although the example is presented for two gNBs, one outdoor and one indoor, three UEs and two sub-bands, it can also be applied to more than two gNBs, more than one outdoor and more than one indoor, more than three UEs and to more than two sub-bands.

When different sub-band partitioning and/or different slot configurations are used by more than one gNB, then the cross-link interference can become more severe compared to using the same sub-band partitioning and the same slot configurations for multiple gNBs with overlapping coverage footprints.

It should be noted that if a (future) UE is capable of full-duplex operation, then further degrees of scheduling for simultaneous reception and transmission in the same slot or OFDM symbol are possible or could be exploited.

Embodiments according to the first aspect relate to:

According to a first implementation of the first aspect a wireless communication scenario is presented, comprising:
a first wireless communication system, WCS, e.g., WCS1 adapted to provide wireless communication to a plurality of communication devices such as UEs, relays, BS, . . . in a first communication area;
a second wireless communication system, WCS, e.g., WCS2 adapted to provide wireless communication to a plurality of communication devices such as UEs, relays, BS, . . . in a second communication area;
wherein the first WCS and/or the second WCS provide a source of inter-WCS interference for the respective other WCS;
wherein the wireless communication scenario is adapted to mitigate the inter-WCS interference.

According to a second implementation of the first aspect the wireless communication scenario of implementation 1 is provided, wherein the second communication area is located adjacent to or overlapping with the first communication area.

According to a third implementation of the first aspect the wireless communication scenario of one of previous implementations is provided, wherein signals of the first WCS cause inter-WCS interference for the second WCS and/or signals of the second WCS cause inter-WCS interference for the first WCS.

According to a fourth implementation of the first aspect the wireless communication scenario of one of previous implementations is provided, wherein the inter-WCS interference comprises at least one of:
a cross-link interference from the first WCS to the second WCS, e.g., a BS of the first WCS operates in Downlink and a BS of the second WCS operates in uplink;
an inter-cell interference from the first WCS to the second WCS, e.g., a BS of the first WCS operates in downlink and a UE of the second WCS operates in downlink;
an inter-cell interference from the first WCS to the second WCS, e.g., a UE of the first WCS operates in uplink and a BS of the second WCS operates in uplink
a cross-link interference from the first WCS to the second WCS, e.g., a UE of the first WCS operates in uplink and a UE of the second WCS operates in downlink;
a cross-link interference from the second WCS to the first WCS, e.g., a BS of the second WCS operates in downlink and a BS of the first WCS operates in uplink
an inter-cell interference from the second WCS to the first WCS, e.g., a BS of the second WCS operates in downlink and a UE of the first WCS operates in downlink;
an inter-cell interference from the second WCS to the first WCS, e.g., a UE of the second WCS operates in uplink and a BS of the first WCS operates in uplink;
a cross-link interference from the second WCS to the first WCS, e.g., a UE of the second WCS operates in uplink and a UE of the first WCS operates in downlink.

According to a fifth implementation of the first aspect the wireless communication scenario of one of previous implementations is provided, wherein the first WCS and the second WCS are operated in adjacent, overlapping or non-overlapping frequency ranges and/or are operated with a same radio access technology, RAT.

According to a sixth implementation of the first aspect the wireless communication scenario of one of one of previous implementations is provided, wherein the first WCS and the second WCS are operated by a same operator such as a mobile network operator, MNO.

According to a seventh implementation of the first aspect the wireless communication scenario of one of one of previous implementations is provided, wherein the first WCS and the second WCS are operated by different operators such as mobile network operators, MNOs.

According to an eight implementation of the first aspect the wireless communication scenario of one of previous implementations is provided, wherein the first WCS and the second WCS operate on at least one same carrier frequency to provide wireless communication.

According to a ninth implementation of the first aspect the wireless communication scenario of implementation 8 is provided, wherein the first WCS and the second WCS are operated by a same operator such as a mobile network operator, MNO; wherein the first WCS and the second WCS are adapted to provide the communication to a common plurality of devices; wherein a coordination entity of the wireless communication scenario is adapted to control at least a part of the first WCS and a part of the second WCS to mitigate the inter-WCS interference.

According to a tenth implementation of the first aspect the wireless communication scenario of implementation 8 is provided, wherein the first WCS and the second WCS are operated by different operators such as mobile network operators, MNOs; wherein the wireless communication scenario comprises a coordination unit adapted for providing coordination for the first WCS and/or the second WCS; wherein a controlling entity of the wireless communication scenario is adapted to control at least a part of the first WCS and/or a part of the second WCS to mitigate the inter-WCS interference.

According to an eleventh implementation of the first aspect the wireless communication scenario of one of implementations 8 to 10 is provided, wherein at least one device communicating in the wireless communication scenario is adapted to measure and report perceived interference to provide a basis for controlling the at least part of the first WCS or part of the second WCS to mitigate the inter-WCS interference.

According to a twelfth implementation of the first aspect the wireless communication scenario of one of previous implementations is provided, wherein the first WCS and the second WCS operate on at least one different carrier frequency to provide wireless communication.

According to a thirteenth implementation of the first aspect the wireless communication scenario of implementation 12 is provided, comprising a coordinating entity adapted for joint coordination of a schedule of a first carrier used in the first WCS and of a second carrier used in the second WCS, e.g., to provide inter-carrier coordination.

According to a fourteenth implementation of the first aspect the wireless communication scenario of implementation 12 or 13 is provided, wherein the first WCS and the second WCS are operated by a same operator such as a mobile network operator, MNO; wherein at least one base station of at least one of the first WCS and the second WCS is adapted for a cross-carrier measurement to measure on a carrier unused by the base station and/or to operate according to a cross-carrier scheduling to mitigate the inter-WCS interference.

According to a fifteenth implementation of the first aspect the wireless communication scenario of one of implementations 12 to 14 is provided, wherein the first WCS and the second WCS are operated by different operators such as mobile network operators, MNOs; wherein the wireless communication scenario comprises a coordination unit adapted for providing coordination for the first WCS and/or the second WCS; wherein a controlling entity of the wireless communication scenario is adapted to control at least a part of the first WCS and/or a part of the second WCS to mitigate the inter-WCS interference.

According to a sixteenth implementation of the first aspect the wireless communication scenario of implementation 15 is provided,
wherein the coordination unit is adapted for providing information, e.g., a signal or a memory/database, to the second WCS, the information indicating a scheduling of the first WCS on at least one carrier to enable a controller of the second WCS to adjust a scheduling of the second WCS with regard to the scheduling first WCS to mitigate the inter-WCS interference; and/or
wherein the coordination unit is adapted for providing information, e.g., a signal or a memory/database], to the first WCS, the information indicating a scheduling of the second WCS on at least one carrier to enable a controller of the first WCS to adjust a scheduling of the first WCS with regard to the scheduling second WCS to mitigate the inter-WCS interference.

According to a seventeenth implementation of the first aspect the wireless communication scenario of one of previous implementations is provided, adapted for measuring an inter-carrier interference present between the first and second wireless communication system, WCS, operated by same or different MNOs; and for mitigating the inter-carrier interference.

According to a eighteenth implementation of the first aspect the wireless communication scenario of one of previous implementations is provided,
wherein a base station of the first WCS is adapted to use a first set of reference signals using first dedicated time/frequency resources; wherein the first dedicated time frequency resources are known by the second WCS; wherein a member of the second WCS is adapted to measure the first set of reference signals to provide a basis for mitigating the inter-WCS interference; and/or
wherein a base station of the second WCS is adapted to use a second set of reference signals using second dedicated time/frequency resources; wherein the second dedicated time frequency resources are known by the first WCS; wherein a member of the first WCS is adapted to measure the second set of reference signals to provide a basis for mitigating the inter-WCS interference.

According to a nineteenth implementation of the first aspect the wireless communication scenario of one of previous implementations is provided,
wherein a member of at least one WCS is adapted to measure a perceived interference and for providing a measurement report for a coordinating entity adapted to coordinate at least a part of the wireless communication scenario to mitigate the inter-WCS interference.

According to a twentieth implementation of the first aspect the wireless communication scenario of implementation 19 is provided,
wherein the member is adapted for measuring and reporting an inter-WCS cross-link interference; and/or
wherein the member is adapted for measuring and reporting an inter-WCS inter-cell interference

According to a twenty-first implementation of the first aspect the wireless communication scenario of one of previous implementations is provided,
wherein a member of at least one WCS is adapted to measure a perceived interference and optionally for providing a measurement report wherein at least one of the member, i.e. the measuring/reporting member and/or an entity receiving the report is configured for adapting at least a part of the WCS in response to the measurement or the report.

According to a twenty-second implementation of the first aspect the wireless communication scenario of one of previous implementations is provided, comprising a coordination unit,
wherein a coordination unit is adapted for providing at least one of:
   an inter-RAT coordination of the first WCS and the second WCS;
   an inter-MNO coordination between a first mobile network operator, MNO, operating the first WCS and a second MNO operating the second WCS
   an inter-cell coordination between cells of a same or different WCS;
   a slot structure coordination between different TDD/sub-band full duplex, SBFD slot structures of a cell; and
   an inter-cell coordination operating in different sub-band full duplex configurations (SBFD).

According to a twenty-third implementation of the first aspect the wireless communication scenario of implementation 22 is provided, wherein, to provide coordination, the coordination unit is adapted to controlling at least one entity of the first WCS and/or the second WCS or for providing information to a controller of one of the first WCS and second WCS about the respective other WCS.

According to a twenty-fourth implementation of the first aspect the wireless communication scenario of implementation 22 or 23 is provided, wherein the coordination unit is adapted for providing an enhanced inter-cell interference coordination, eICIC being intra-carrier, intra-MNO and/or inter-cell, e.g. macro-picocell coordination.

According to a twenty-fifth implementation of the first aspect the wireless communication scenario of one of previous implementations is provided, wherein the first WCS is operated as a mobile communication network in one of a time division duplex, TDD, frequency division duplex, FDD, Sub-band full duplex (SBFD) and/or full duplex scheme; and/or wherein the first WCS is operated as a mobile communication network in one of a time division duplex, TDD, frequency division duplex, FDD, Sub-band full duplex (SBFD) and/or full duplex scheme

According to a twenty-sixth implementation of the first aspect the wireless communication scenario of one of previous implementations is provided, wherein one of the first WCS and the second WCS, when perceiving, as a victim, the inter-WCS interference from the other WCS as an aggressor, is adapted for determining a communication device suffering from the inter-WCS interference, e.g., above a threshold value, and for scheduling the suffering communication device to a communication resource being less affected by the inter-WCS interference from the perspective of the suffering device.

According to a twenty-seventh implementation of the first aspect the wireless communication scenario of one of previous implementations is provided, wherein one of the first WCS and the second WCS, when perceiving, as a victim, the inter-WCS interference from the other WCS as an aggressor, is adapted for determining an interference information indicating at least one of:
the inter-WCS interference is based on different TDD slot structures operated in at least parts of the first WCS and the second WCS
only a subset of communication devices experiences significant interference from the aggressor,
only a subset of downlink, DL, time resources such as DL slots, frames, symbols, used by the victim experience significant interference from the aggressor;
only a subset of DL frequency resources such as carriers, DL BWPs or DL spectral resources used by the victim experience significant interference from the aggressor;
only a subset of DL channels such as user plane, UP or control plane, CP, channels, used by the victim experience significant interference from the aggressor;
only a subset of uplink, UL, time resources such as UL slots, frames, symbols, used by the victim experience significant interference from the aggressor;
only a subset of UL frequency resources such as carriers, UDL BWPs or UL spectral resources used by the victim experience significant interference from the aggressor;
only a subset of UL channels such as user plane, UP or control plane, CP, channels, used by the victim experience significant interference from the aggressor.

According to a twenty-eight implementation of the first aspect the wireless communication scenario of implementation 27 is provided, wherein a controller of the victim is adapted for, based on the interference information, at least one of:
schedule any communication device on “unaffected” or “moderately affected” radio resources, e.g. DL slots which are simultaneously operated by a 1^{st} WCS and a 2^{nd} WCS;
schedule unaffected or moderately affected communication devices, e.g. a UE which is indoors and therefore better isolated from an interfering base station outdoors, or groups thereof onto any radio resources available to the victim which have been identified due to individual reports of the communication devices, to be suitable for DL use;
schedule system information or user specific information, e.g. CORESETs or other control channels into radio resources which are unaffected or moderately affected by the inter-WCS interference from the aggressor.

According to a twenty-ninth implementation of the first aspect the wireless communication scenario of implementation 27 or 28 is provided, wherein the controller of the victim is adapted, based on the interference information, for at least one of:
controlling the victim to provide interference measurements of the victim more frequently,
applying statistical interference mitigation techniques such as frequency hopping, coding over longer periods, repetition coding, low MCS modes, etc.,
applying interference pattern identification and prediction methods, and
applying a priori knowledge about future interference scenarios on radio resources or about communication devices, e.g., through interference coordination by e.g. beam coordination or coordinated patterns of radio resources between the victim and the aggressor.

According to a thirtieth implementation of the first aspect the wireless communication scenario of one of implementations 27 to 29 is provided, wherein a controller of the victim or of the aggressor is adapted for observing and learning a pattern or behaviour, e.g., of its own and/or of the other WCS, and its associated interference impact onto at least one of its communication devices or entities;
for predicting future availability or resources or interference impact onto at least one of its communication devices or entities;
for applying appropriate radio resources allocation or user scheduling strategies to mitigate expected interference impacts.

According to a thirty-first implementation of the first aspect the wireless communication scenario of one of previous implementations is provided, wherein one of the first WCS and the second WCS, when perceiving, as a victim, the inter-WCS interference from the other WCS as an aggressor, is adapted for determining interference information indicting at least one of:
information indicating that many or a dominant number of communication devices of the victim experience significant interference from the aggressor on a share being at least a threshold, e.g., most or all radio resources available to the victim; e.g., a situation where no or insufficient number of safe or unaffected radio resources are available to serve many users or the communication devices,
particular Downlink, DL, time resources such as DL slots, frames, symbols, used by the victim, e.g. SSBs experience significant interference from the aggressor or at least a considerable number thereof, e.g., an insufficient number of time resources considered to be safe-guarded,
particular DL frequency resources such as carriers, DL BWPs or DL spectral resources used by the victim, e.g. SSBs experience significant interference from the aggressor or at least a considerable number thereof, e.g., insufficient number of time resources considered to be safe-guarded,
important/system relevant/system performance relevant DL channels such as user plane, UP, and/or Control plane, CP, channels used by the victim experience significant interference from the aggressor,

According to a thirty-second implementation of the first aspect the wireless communication scenario of one of implementations 27 to 31 is provided, wherein a controller of the victim is adapted for, based on the interference information, at least one of:
contributing to a radio resource coordination between the victim and the aggressor;
safeguarding certain radio resources for the victim or the aggressor, e.g.,
   applying semi-persistent radio resource allocations for TDD slot configurations, SBFD configurations, beam directions, beam allocation orders, power spectral densities, transmit power, muting of RE, BWPs, slots etc. (system information exchange between the two WCSs might be sufficient when done once, occasionally, request-based or event-based, when system information changes have been made).
   Exchange of future radio resource allocations between the victim and the aggressor;
   Operating according to an aligned or coordinated behaviour or configuration of the victim and the aggressor to allow a sufficient number of radio resources available for at least one of the two WCS, sufficient number of communication devices belonging to at least one WCS to be served reliably according to a targeted service level (QoS) of that particular WCS;
   At least one of the WCSs observes and learns patterns or behaviour and its associated interference impact onto at least one of its devices or entities and predicts future availability of resources or interference impact onto at least one of its devices or entities and applies appropriate radio resources allocation or user scheduling strategies to mitigate expected interference impacts.

According to a thirty-third implementation of the first aspect the wireless communication scenario of implementation 31 or 32 is provided, wherein a controller of the victim or of the aggressor is adapted for observing and learning a pattern or behaviour, e.g., of its own and/or of the other WCS, and its associated interference impact onto at least one of its communication devices or entities.

According to a thirty-fourth implementation of the first aspect the wireless communication scenario of implementation 33 is provided, wherein the victim and the aggressor are adapted for evaluating a coordination mechanism regarding its effectiveness and/or efficiency for mitigating the inter-WCS interference in order to coordinate the coordination mechanism with the other WCS.

According to a thirty-fifth implementation of the first aspect the wireless communication scenario of one of previous implementations is provided, wherein the inter-WCS interference is constant, quasi-static, semi-persistent or gradually/slowly changing.

According to a thirty-sixth implementation of the first aspect the wireless communication scenario of one of previous implementations is provided, wherein the first WCS and the second WCS are adapted to implement at least one of:
operating based on a same radio access technology, RAT;
operating based on time division duplexing (TDD);
operating based on sub-band full duplexing (SBFD);
operating based on a hybrid combination of any of FDD, SBFD and TDD;
operating based on a TDD scheme that is similar or different to the TDD scheme of the other WCS;
operating based on a SBFD scheme that is similar or different to the SBFD scheme of the other WCS;
operating based on a hybrid scheme that is similar or different to the hybrid scheme of the other WCS;
being operating by the same or a different mobile network operator (MNO) as the other WCS.

According to a thirty-seventh implementation of the first aspect a communication device is provided, configured for operating in the first WCS or the second WCS a wireless communication scenario of one of previous implementations.

According to a thirty-eighth implementation of the first aspect a coordinating node is provided, configured for operating in the first WCS or the second WCS a wireless communication scenario of one of previous implementations.

According to a thirty-ninth implementation of the first aspect a method for operating at least one device of the first WCS or the second WCS a wireless communication scenario of one of previous implementations is provided.

According to a fortieth implementation of the first aspect the computer readable digital storage medium having stored thereon a computer program having a program code for performing, when running on a computer, a method according to implementation 39 is provided.

FIG. 12 shows schematic diagrams of possible implementations of flexible slots according to embodiments. FIG. 12 shows different options of arranging uplink and downlink bandwidth parts, BWP, and also presents a state of the art, SOTA, deployed configuration in DDDDDDD SUU and a flexible TDD structure of different MMOs 1, 2 and 3 using the same spectrum with different shares of UL and DL causing potentially inter-MNO coexistence issues.

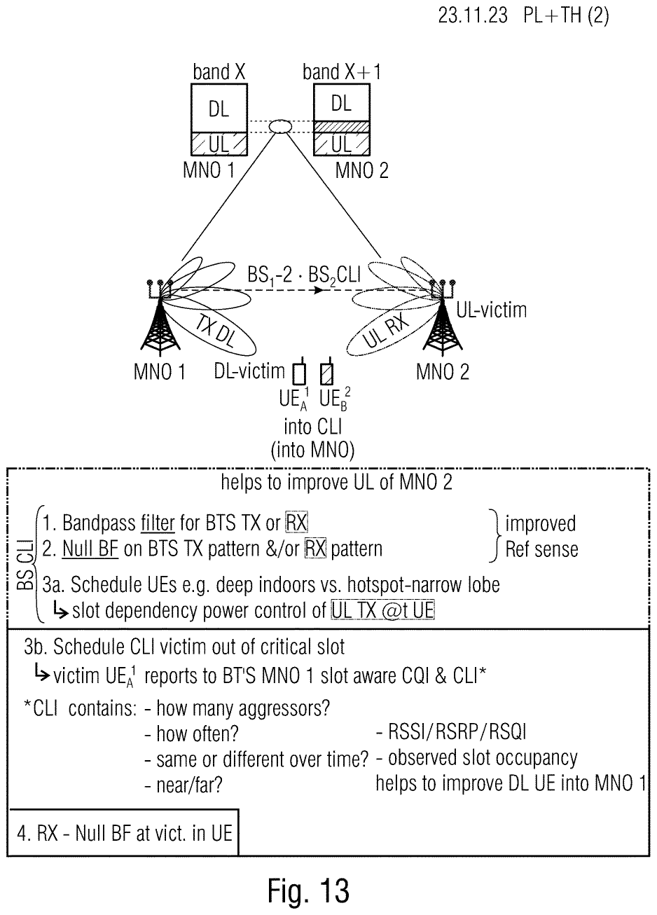

FIG. 13 shows schematic diagrams of possible further implementations of flexible slots according to embodiments. FIG. 13 shows a scenario of inter-MNO issues. A bandpass filter for a BTS TX or RX, a null beam forming on BTS TX pattern and/or RX pattern may help to improve uplink of MNO 2 and/or may allow for an improved Ref sense. Alternatively or in addition, scheduling UEs e.g., deep indoors versus hotspot-narrow lobe as a slot dependency power control of transmission at the UE. Alternatively or in addition, a CLI victim may be scheduled out of a critical slot. A victim, e.g., UE_{A}¹ may report to BTS of NMO 1 a slot aware CQI and a CLI, wherein the CLI may contain how many aggressors are present, how often disturbances are perceived, a near or far distance, whether a same or different over time is experienced, an RSSI/RSRP/RSQ and/or an observed slot occupancy. This may help to improve DL UE of UE1.

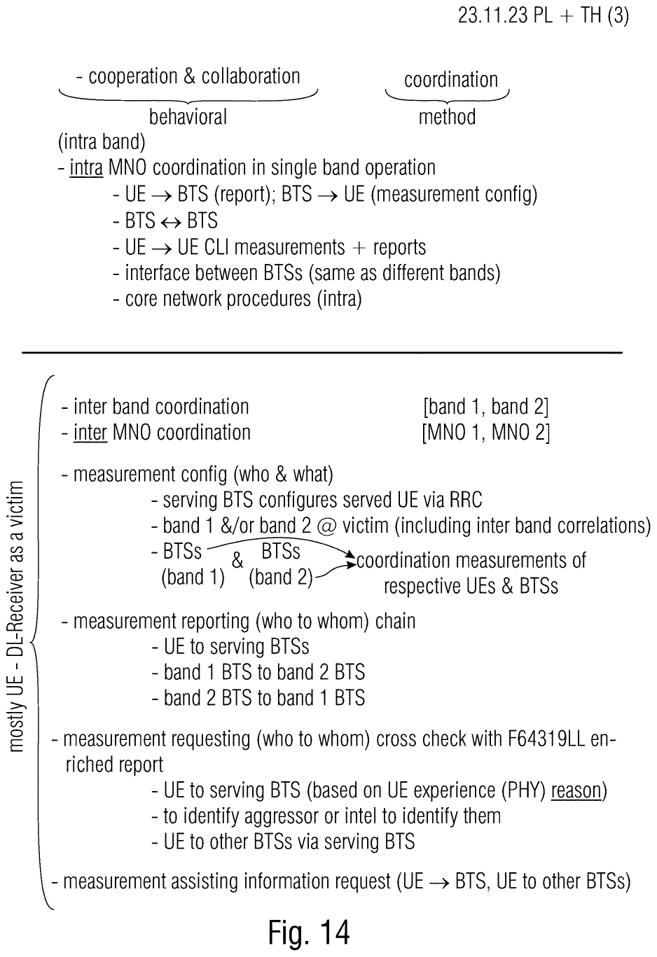

FIG. 14 shows schematic diagrams of possible further implementations of flexible slots according to embodiments. FIG. 14 presents concepts of cooperation and collaboration relating to the behavior, and to the coordination which represents a method. In intra-band, an intra MNO coordination in single band operation may relate to a UE→BTS report, a BTS→UE measurement config). Alternatively or in addition, BTS may exchange messages or measure air interference. UE→UE CLI measurement reports are part of embodiments described herein. An interface between BTSs may be used in same or different bands. Core network procedures may be used for intra-band concepts.

An inter-band coordination, e.g., [band 1, band 2] and/or an inter MNO coordination [MMO1, MMO2] may be used. A measurement config defining who and what has to be measured/reported may relate to a serving BTS configuring a served UE via RRC. This may relate to band 1 and/or band 2, e.g., the victim, including interband/intraband correlations. BTSs of different bands (band 1, band 2) may coordinate measurements of the respective UEs and/or the BTSs. A measurement periodicity may also be configured, e.g., relating to who has to report to whom. The EU may report to the serving BTS. Alternatively or in addition, the band 1 BTS may report to the band 2 BTS and/or band 2 BTS to band 1 BTS. Alternatively or in addition, a measurement requesting may be defined (who and to whom), e.g., a UE to the serving BTS, e.g., based on a UE experience on a PHY reason, e.g., to identify an aggressor or INTEL to identify them. A UE may also send to other BTS via a serving BTS. Alternatively or in addition, a measurement assisting information request may be used, e.g., from the UE to the BTS, to the UE to other BTSs. For example, mostly a UE, e.g., a DL receiver, may serve as an anchor.

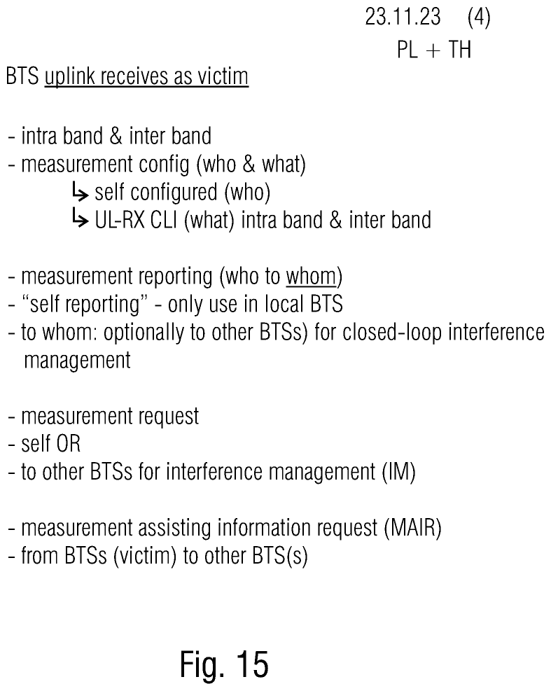

FIG. 15 shows schematic diagrams of possible further implementations of flexible slots according to embodiments. A BTS as an uplink as an receiver may be a victim. This may relate to intraband and interband and may be addressed by measurement config, e.g., who and what has to be reported. This may be a self-configured function (who) and may relate to UL-RX CLI (what) in intraband and/or interband. Further, as an alternative or in addition, a measurement reporting (who and to whom) may be a self-reporting e.g., only using in local BTS. To whom may be addressed by optionally reporting to other BTSs for a closed loop interference management. Alternatively or in addition, a measurement request may be a self-request and/or may be a request to other BTSs for interference management (IM). A measurement assisting information request (MAIR) may be used as an alternative or in addition as well as a report or such a transmission from BTS to the victim and/or to other BTSs.

### Aspect 2: TN-NTN Coordination

The integration of satellite technology with cellular mobile networks has been a longstanding concept. In the mid-1990s, the International Telecommunications Union (ITU) introduced the IMT-2000 (International Mobile Telecommunications 2000) initiative, aiming to achieve global wireless access in the 21st century. This initiative led to the establishment of the Third-Generation Partnership Project (3GPP) and the development of standards such as CDMA-2000 (Code Division Multiple Access 2000), UMTS (Universal Mobile Telecommunications System), and TD-CDMA (Time Division-Code Division Multiple Access), collectively known as 3G. The IMT-2000 initiative was designed to encompass both terrestrial and satellite components, with the ITU-R (ITU Radiocommunication Sector) producing various reports on the satellite aspect of IMT-2000 [1]. However, due to the high costs and insufficient user demand, the implementation of a satellite-based 3G network was not pursued.

In the present day, an increasing number of LTE and 5G users prioritize ubiquitous connectivity over increased data rates [2,3]. Given that many individuals travel to remote areas with no existing connectivity, satellite technology has emerged as a convenient solution to provide such services. Consequently, the development of direct-to-cellular 5G satellite NTN (non-terrestrial networks) has become a prominent and essential objective. Moreover, it is anticipated that satellites will play an integral role in future 6G technology, necessitating the establishment of suitable conditions for the development of 5G-6G satellite networks. Securing enough spectrum for such networks remains one of the most challenging issues in achieving this goal.

For example, the United States and Europe are currently engaged in deliberations regarding frequency allocation plans, specifically focusing on the lower C band, to facilitate the implementation of 5G applications. This segment of the electromagnetic spectrum offers 5G technology a greater bandwidth compared to traditional lower mobile frequency bands. It is worth noting that the C band is presently utilized for satellite downlinks to satellite earth stations (SES), thereby necessitating careful consideration during the allocation process. In addition to C band, L band and S band frequency spectrum is also of interest to both terrestrial network (TN) operators and non-terrestrial (NTN) operators alike. As 3GPP 5G NR includes both TN and NTN, spectrum allocation benefits from being carefully allocated on the one hand and appropriately coordinated on the other.

In connection with the second aspect, there is described at least parts of the problem set to be solved. It begins with an introduction of radio frequency spectrum allocation, then sets out a generic problem definition before detailing several specific problems. The latter are developed to later define a set of accompanying or associated solution proposals. Whilst the problem and solution set is based on the examples given, it is important to note that they present problem types which could be described by other specific examples. In this sense, the set of specific examples is used to provide a more general relationship between known or expected problems and their solution.

### Radio Frequency Spectrum Allocation

As a background of embodiments relating to the second aspect, reference is made to the section radio frequency spectrum allocation described for the first aspect, including problems and solutions realizing embodiments that are described therein.

### Spectrum and Radiowave Propagation

As a background of embodiments relating to the second aspect, reference is made to the section spectrum and radiowave propagation described for the first aspect, including problems and solutions realizing embodiments that are described therein.

Spectrum sharing in L-, S- and C-band

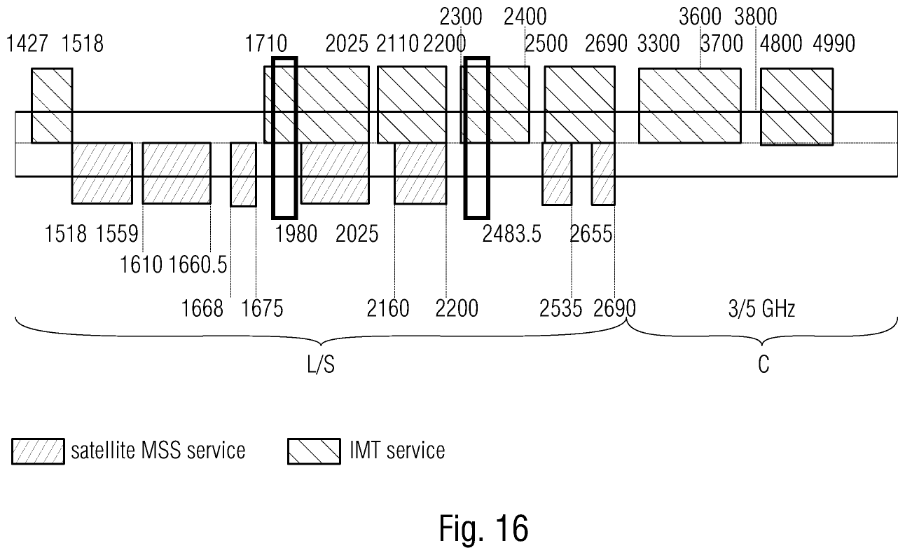

Even though radio frequency spectrum is allocated on a regional basis, an overlap can occur in some regions. For example, FIG. 16 shows the overlapping allocation of spectrum to mobile satellite service (MSS) and international mobile telecommunications (IMT) services. More particularly, FIG. 16 shows a graphical representation of the ITU frequency spectrum assignment for mobile-satellite service (MSS) and international mobile telecommunications (IMT) services, applicable, for example, to the satellite illustrated in FIG. 1. It is noted that if no satellite mobile service is assigned to a given frequency band, then satellites (including satellite space stations) and satellite earth stations cannot be used in those bands. In other words, satellite MSS can only use MSS spectrum.

The C-band Fixed Satellite Service (FSS) has been a cornerstone of global telecommunications infrastructure for over five decades, supporting diverse sectors such as businesses, governments, and consumers. This spectrum has facilitated socio-economic development on a global scale. The substantial investments made by governments, commercial entities, and various users, alongside satellite operators, have resulted in the deployment of approximately 200 geostationary satellites utilizing C-band frequencies. Notably, the unique propagation characteristics and resilience to rain fade make C-band spectrum particularly adept at providing robust multi-continental coverage.

The emergence of terrestrial 5G technology has prompted considerable interest in repurposing the C-band spectrum, intensifying the debate surrounding its allocation. Regulators are now confronted with the formidable task of reconciling the allure of 5G and its potential benefits with the indispensable role of satellite services, which have been relied upon for over half a century. Consequently, regulators are compelled to meticulously weigh the technical and economic considerations associated with this decision-making process.

Should regulators opt to permit the use of C-band for terrestrial 5G services, it is imperative that they address the following critical aspects:
Balancing the requirements of C-band satellite services with the legitimate spectrum needs of mobile service providers;
Implementing appropriate technical measures to safeguard the uninterrupted operation of C-band FSS in the presence of terrestrial services, thereby mitigating the risk of interference.

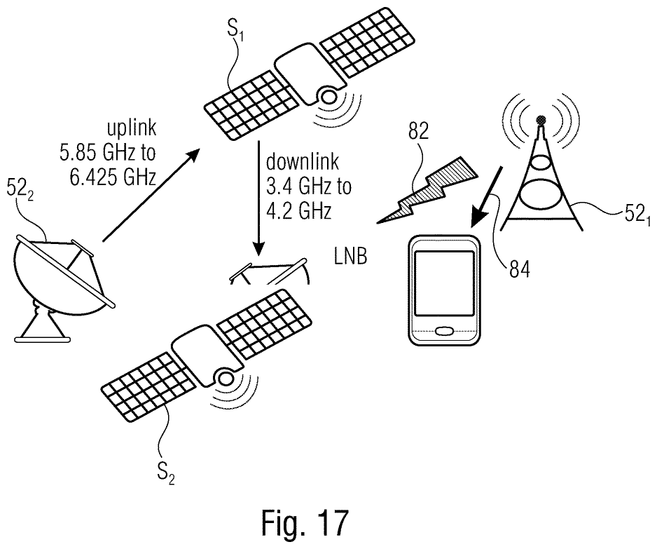

In the United States, the C band spectrum downlink frequency allocation ranges from 3.7 GHZ to 4.2 GHZ, while in Europe, it spans from 3.4 GHz to 4.2 GHZ. This frequency band is particularly advantageous for supporting telecommunications and broadcasting services in rural and marine areas where terrestrial infrastructure is limited or non-existent. One notable advantage of the C band is its resistance to rain fade, making it suitable for establishing stable links in tropical regions. Moreover, services operating in the C band play a crucial role in emergency situations and disaster recovery efforts. However, sharing the same frequency spectrum with other entities introduces the possibility of interference 82 as shown, for example, in FIG. 17 illustrating a potential interference scenario in C band.

Such interference 82, e.g., caused by downlink signals 84 transmitted from basestation 52₁ (or vice versa) can lead to saturation of the low noise blocks (LNB) in the downlink, e.g., where satellite S₁ transmitts. Unfortunately, the existing receiving systems of fixed and mobile earth stations 52₂, S₂ lack the capability to apply filters to mitigate this interference. Furthermore, the received signal, weakened by its journey of up to 36,000 km from a geostationary orbit to Earth, becomes too faint to be detectable. While regulatory limits offer guidance for planning cellular networks, they cannot guarantee that waves will not propagate beyond the predicted range.

### Frequency Reuse in Cellular Systems

As a background of embodiments relating to the second aspect, reference is made to the section frequency reuse in cellular systems described for the first aspect, including problems and solutions realizing embodiments that are described therein.

### Interference Management

As a background of embodiments relating to the second aspect, reference is made to the section interference management described for the first aspect, including problems and solutions realizing embodiments that are described therein.

### Terrestrial and Non-Terrestrial Network Services

As depicted FIG. 16, the case of co-allocation of the same or overlapping spectrum for terrestrial and non-terrestrial usage (satellite), inter-system interference in overlapping footprints is to be expected and embodiments provide solutions to be handled by appropriate means.

Assuming, that the NTN-spectrum and the TN-spectrum are owned and operated by the same or associated operators and furthermore the two systems use the same technology, e.g. 4G-LTE or 5G-NR, then the co-existence problem could be addressed and handled by using already existing techniques together with additional novel techniques proposed by this invention disclosure. Some particular scenarios may require enhancements of existing techniques, novel solution components or combinations thereof.

These novel techniques addressing/solving one or several of the above problem sets include:
Interference measurement means including reference signals (RS) and dedicated time frequency resources for intersystem interference measurements
Reporting mechanisms for intercell interference in DL and UL (intra-band and inter-band)
Reporting mechanisms for intersystem crosslink interference (CLI) in DL and UL (intra-band and inter-band)
Intersystem coordination channels and associated protocol
eICIC extensions dedicated to intersystem interference (co-deployment of TDD and FDD operation)
   Further Explanations of Terms Used in Connection with Interference Mechanisms According to the Invention

As a background of embodiments relating to the second aspect, reference is made to the section Further explanations of terms used in connection with interference mechanisms according to the invention described for the first aspect, including problems and solutions realizing embodiments that are described therein.

Further, when referring to FIG. 5 and FIG. 6 it may be seen, that issues and, thus, also presented solutions, that refer herein to one of the uplink and the downlink may be derived for the respective other part, the downlink, the uplink respectively.

The terms cross-link interference (CLI) and inter-cell interference (ICI) are to differentiate the kind of co-channel interference (CCI), wherein e.g. in ICI a UE receiver experiences interference from another BS or a BS receiver experiences interfering signals from UEs served by another BS. CLI describes e.g. the fact that a UE receiver experiences interference coming from a UE transmitting to a BS while the victim UE is receiving signals from its serving BS. A similar interference scenario is when a BS receiver is interfered by a BS transmitting e.g. in Downlink causing severe interference for the UL signals from a UE served by the victim BS. Furthermore, it has to be noted that ICI and CLI can be intra-band, inter-band or combination thereof.

A Generic Problem Set in Connection with the Second Aspect

In general, the related problem statement refers to the following use cases:
1. Solving co-existence between two different wireless communication systems operated in overlapping spectrum and with overlapping coverage footprint (e.g. NTN and TN co-deployment)
2. Solving co-existence between two similar (e.g. same numerology) wireless communication systems operated in overlapping spectrum and with overlapping coverage footprint (neighbour cells of same MNO and same spectrum operated with different slot structure)
3. Solving co-existence between two different wireless communication systems operated in adjacent spectrum and with overlapping coverage footprint. (e.g. Rail and public networks at 1900 MHz)
4. Solving co-existence between two similar (e.g. same numerology) wireless communication systems operated in adjacent spectrum and with overlapping coverage footprint (e.g. different MNOs using different slot structures, Flexible TDD or SBFD)

As indicated in connection with aspect 1 whilst items 2 and 4 are at least mainly addressed by the first aspect of the present disclosure, items 1 and 3 are mainly addressed by the second aspect.

It is mentioned that a further side constraint may harden or relax the problem set to be solved which is the aim/target to minimize interdependencies between bands, which cause or suffer from intra-band, inter-band or inter-system interference. A classic example is given by two MNOs operating adjacent spectrum with certain TDD slot configurations which create interference coupling and therefore has performance impact on part or all the radio resources use by each MNO. A good solution should provide a sweet spot between rigid coordination configuration coordination long term and over large areas, e.g. like today's synced TDD slot structures and flexibility in achieving a e.g. different UL/DL ratio used by the two MNOs. Such solutions allow independent scheduling and RRM decisions to be made by each MNOs subject to some reasonable effort on inter-MNO coordination.

A similar example can be a TN-MNO and an NTN-MNO using nearby/overlapping spectrum with overlapping footprint. Again, inter-system coordination should be kept reasonable while each system can operate with its radio resources according to well established/proven mechanisms. Such willingness to coordinate configurations is easier to be obtained if joint or complementing interests of the two MNOs in the given examples are given, e.g. partnerships between NT & NTN to fill coverage holes or boost capacity for users in co-deployment situations. While such mutually benefitting settings may become trailblazing for market introduction, mechanisms used to facilitate these use cases may become mandated or considered as standard means to handle interference of similar kind even for MNOs or systems which don't benefit explicitly or in a balanced way when inter-band or intersystem coexistence requirements are relaxed.

A part of the solution statement provided in connection with the second aspect will describe UE requirements for configuration, measurement and reporting of the following:

### A Set of Specific Problems

In general, inter-cell interference coordination (ICIC) is needed to manage spectrum usage so that the risk or the effects of cross-link interference (CLI) and co-channel interference (CCI) are at best minimized or at worst, reduced. This sub-section provides a detailed set of examples that illustrate both CLI and CCI. However, whilst the examples given relate to a specific combination of frequency bands for mobile satellite services and mobile terrestrial services, they can also be applied to other services and band combinations.

### E-UTRA Bands 23, 32 and NR Bands n66 and n70

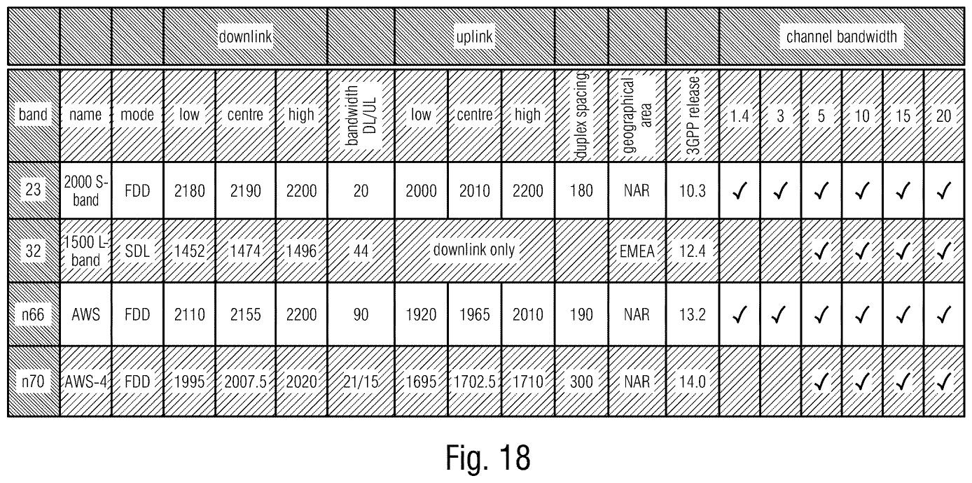

By way of example, an operator that is licensed to operate services may use a variety of frequency bands. Similarly, we could consider two or more than two operators that provide a joint or combined service offering, again using a variety of frequency bands. In this case, we consider the E-UTRA bands 23, 32 and NR bands n66 and n70 as detailed in the table shown in FIG. 18. The table shows an example illustration of a frequency spectrum arrangement of 3GPP-defined bands 23, 32, n66 and n70 together with details of their bandwidth, the supported channel bandwidth, duplex spacing, geographical area and associated 3GPP release. All frequencies are in megahertz (MHz).

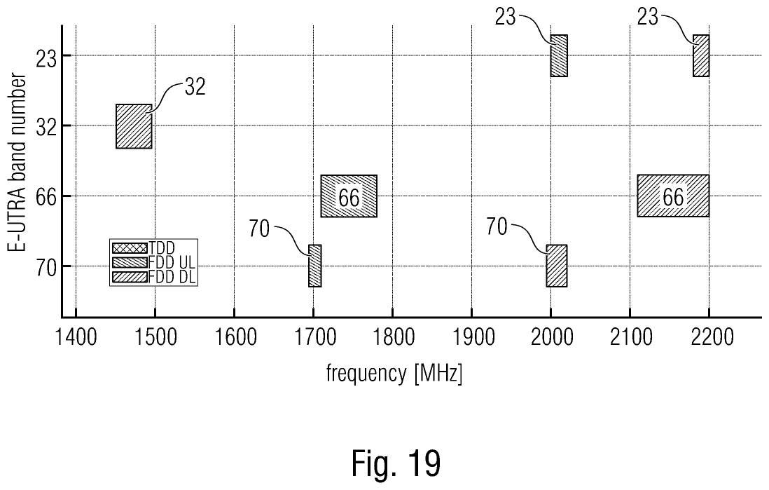

The numerical details presented in FIG. 18 are illustrated in FIG. 19 showing a graphical representation of the E-UTRA bands 23, 32, 66 and 70 and from which the following spectrum assignment overlaps can be seen: Band 23 uplink and n70 downlink; and Band 23 downlink and n66 downlink. Note that bands 66 and 70 are also defined for 5G-NR as n66 and n70.

As noted in the table of FIG. 18, within a given band, different channel bandwidth configurations are possible. For example, band n66 allows channel bandwidths of 1.4, 3, 5, 10, 15 and 20 MHz to be used. The choice of channel bandwidth is related to the serve being offered—for example, narrow-band Internet-of-thing (NB IoT) service operate with a 1.4 MHz channel bandwidth whereas mobile broadband (MBB) and enhanced MBB (eMBB) service are operated with much larger channel bandwidths which might sometimes be aggregated to achieve yet broader bandwidths. In practice, an MNO will hold a licence for a given range of frequency spectrum within a given band and according to the channel bandwidth.

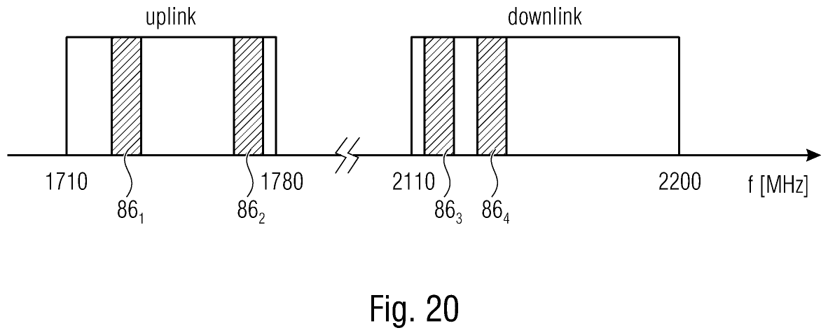

In another embodiment presented in FIG. 20 presents a view of EUTRA band 66 (also NR band n66) in which an MNO has been assigned two 10 MHz bandwidth channels 86₁ and 86₂, 86₃ and 86₄ respectively in both uplink and downlink. That is, FIG. 20 shows an example of a single MNO's channel bandwidth allocation in band 66.

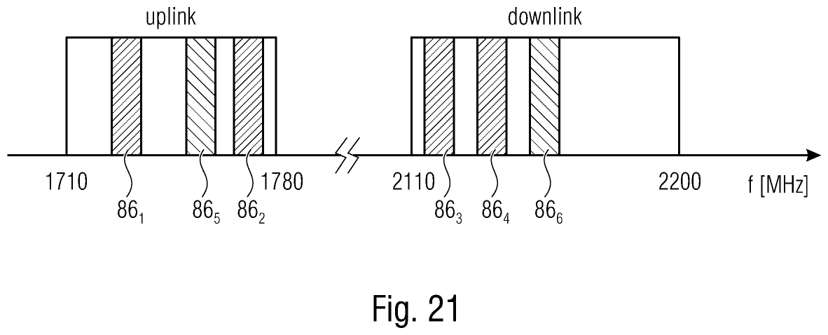

In another embodiment of FIG. 21, a second MNO has been assigned a single 10 MHz channel 865 and 866 in both uplink and downlink. That is, FIG. 21 shows an example of a two MNOs' channel bandwidth allocation in band 66.

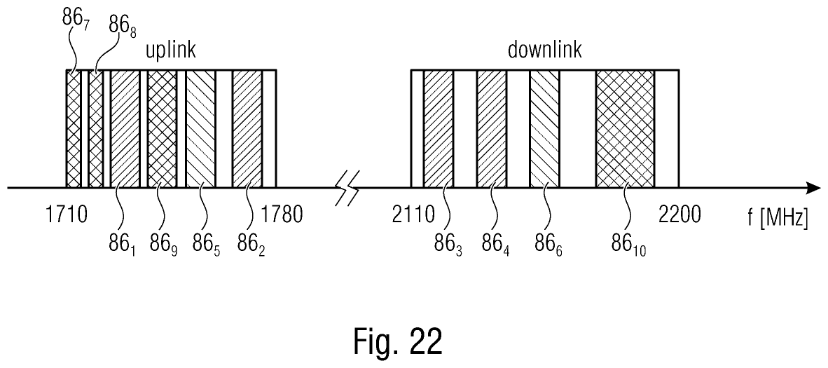

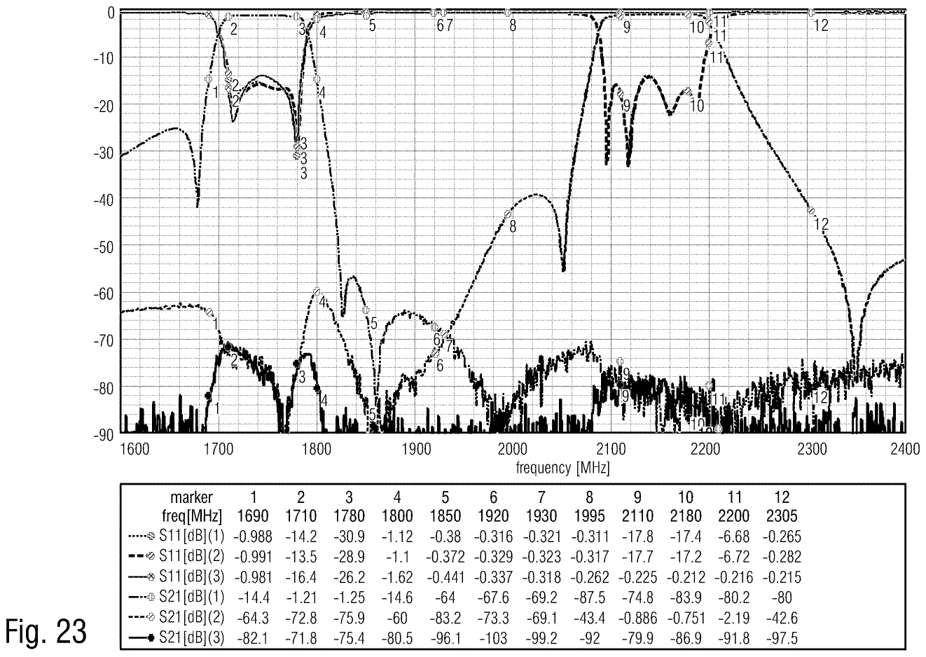

In another embodiment presented in FIG. 22 the addition of a third MNO that has been allocated two 5 MHz channels 86₇ and 86₈ and one 10 MHz channel 86₉ in uplink and one 20 MHz channel 86₁₀ in downlink is shown. That is, FIG. 22 shows an example of a three MNOs' channel bandwidth allocation in band 66.

Even though each MNO may uses different frequency ranges of band 66, the radio frequency (RF) front-end of a basestation will be equipped with a duplexing filter that is designed for the full band rather than parts of it as shown in FIG. 23 illustrating an example S-parameter description of a band 66 small-cell basestation duplex filter: The same is true for the user equipment device, the possibly but not necessarily only difference being that the RF performance of the basestation duplexer is typically superior to that of the UE's.

### Band Usage

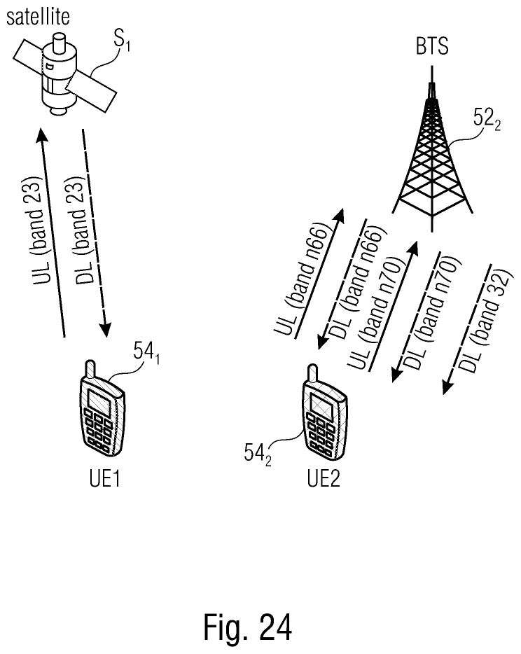

The operator(s), who are licensed to operate using the frequency bands shown in FIG. 19, may provide a combination of satellite services (e.g., using Band 23) and terrestrial services (e.g., using Band 32 and/or bands n66 and/or n70) as shown in FIG. 24. In other words, NTN services are provided via Band 23 and TN services via bands n66, n70 and supplemental downlink (SDL) Band 32. In other words, FIG. 24 shows a pictorial presentation of a satellite providing services to UE1 54₁ and a BTS 52₂ providing services to UE2 54₂. The downlink (DL) and uplink (UL) bands are shown for both the non-terrestrial network (NTN) and the terrestrial network (TN) services.

### Four Interference Scenarios

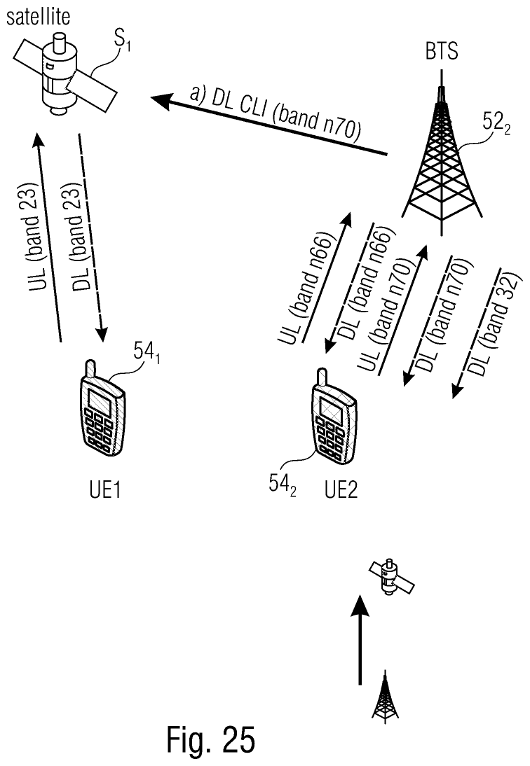

An analysis of the spectrum allocation shown in FIG. 19 and the deployment scenario of FIG. 24 may lead to the following four potential interference situations drawn in FIG. 25 to FIG. 28.

According to the embodiment of FIG. 25, an example of BTS-to-satellite cross-link interference (CLI) is illustrated. Signals from BTS 52₂ transmissions in Band n70 downlink cause the risk of CLI affecting satellite S₁ reception in Band 23 uplink.

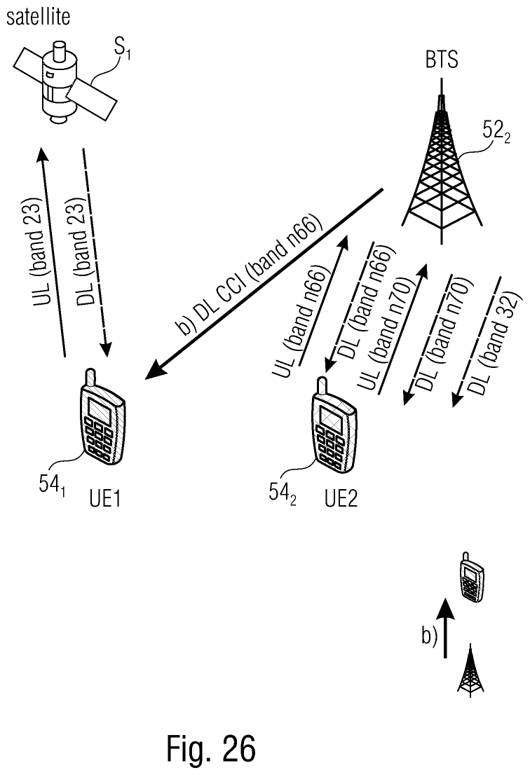

According to the embodiment of FIG. 26, an example of BTS-to-UE1 co-channel interference (CCI) is illustrated. Signals from BTS 52₂ transmissions in Band n66 downlink cause the risk of CCI affecting UE1 54₁ reception in Band 23 downlink.

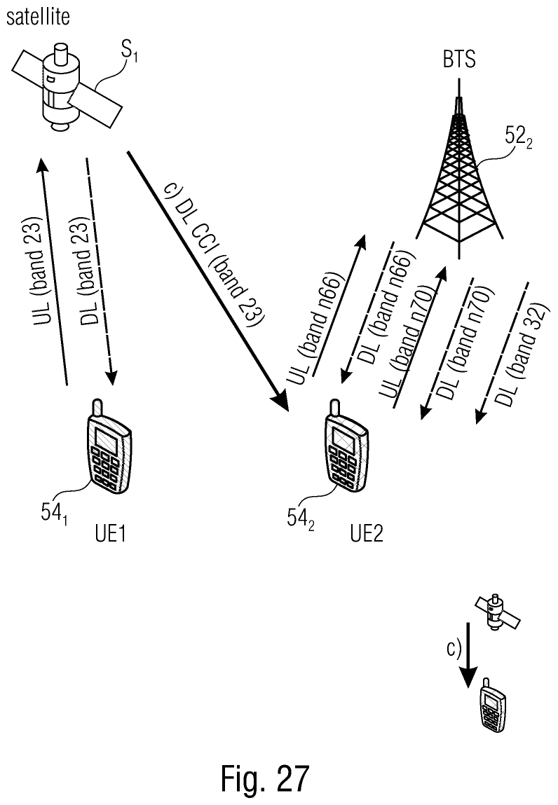

According to the embodiment of FIG. 27, an example of Satellite-to-UE2 co-channel interference (CCI) is illustrated. Signals from satellite transmissions in Band 23 downlink cause the risk of CCI affecting UE2 54₂ reception in Band n70 downlink.

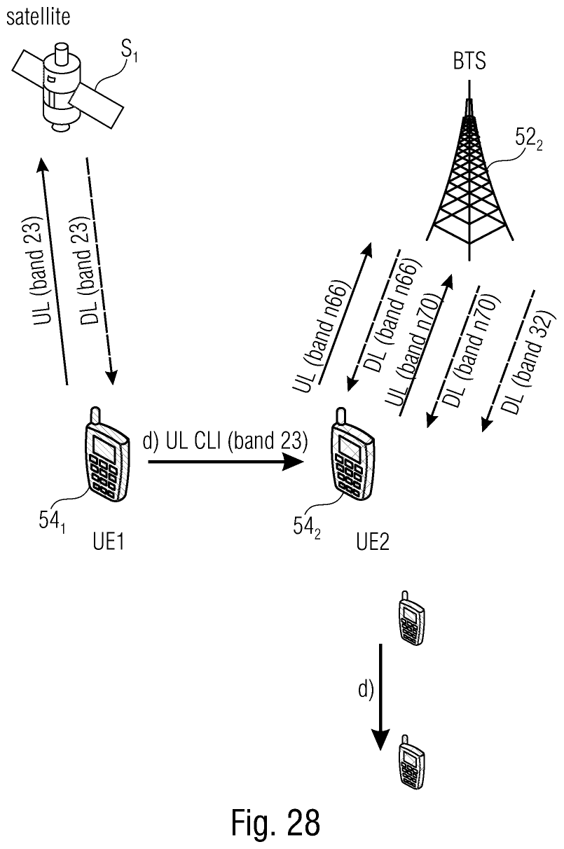

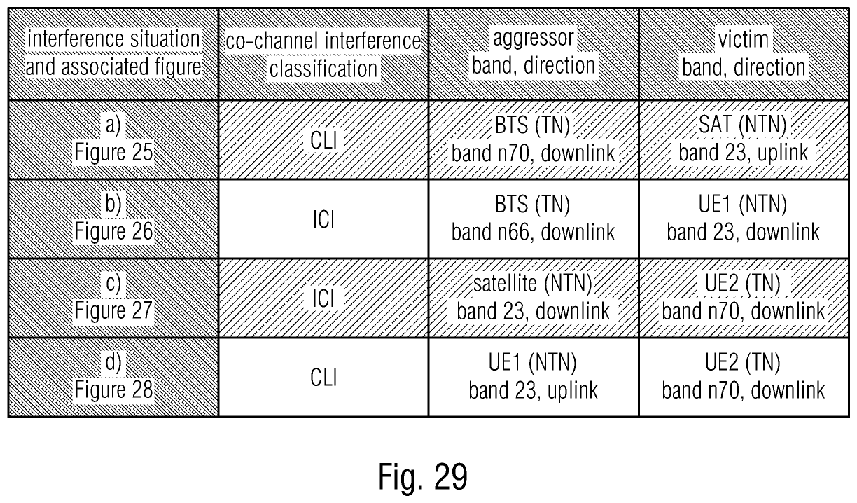

According to the embodiment of FIG. 28, an example of UE1-to-UE2 cross-link interference (CLI) is illustrated. Signals from UE1 54₁ transmissions in Band 23 uplink cause the risk of CLI affecting UE2 54₂ reception in Band n70 downlink

The details of the four potential interference situations drawn in FIG. 25 to FIG. 28 are summarized in the table of FIG. 29 which records the interference classification-cross-link interference (CLI) and co-channel interference (CCI)—the source of the interference—the “aggressor”—and the unfortunate recipient of the interference—the “victim”. Further details relating to the aggressor and victim are also tabulated.

### Cross-Link Interference Reduction

The 3GPP specifications address specific methods to combat cross-link interference, particularly in the context of Time Division Duplex (TDD) networks. One approach involves the use of reconfigurable TDD configurations to mitigate cross-link interference between neighbouring base stations transmitting in the downlink (DL) and the uplink (UL). This solution utilizes a TDD configuration to determine the mapping for UL control information, ensuring that the UL control information is transmitted in UL subframes unaffected by cross-link interference. Additionally, the timing of Hybrid Automatic Repeat reQuest (HARQ) transmissions is determined based on a mapping specific to the TDD configuration used in the cell, thereby minimizing the impact of cross-link interference on UL control information transmission.

Alternative approaches to combat cross-link interference in Time Division Duplex (TDD) networks include the utilization of advanced interference mitigation techniques, such as beamforming and interference cancellation, to effectively manage and suppress cross-link interference. By leveraging beamforming capabilities and interference cancellation algorithms, base stations can dynamically adapt their transmission and reception patterns to mitigate the impact of cross-link interference, thereby enhancing the overall performance and reliability of TDD networks.

Furthermore, the deployment of advanced antenna technologies, including massive MIMO (Multiple-Input Multiple-Output), can also serve as an alternative approach to combat cross-link interference. Massive MIMO systems leverage many antennas to spatially separate and distinguish between desired signals and interference, enabling enhanced interference suppression and improved signal reception in the presence of cross-link interference.

### Inter-Cell Interference Reduction

The 3GPP specifications and industry discussions highlight specific methods employed in mobile communication to combat co-channel interference and crosstalk in the form of inter-cell interference. Some of these methods include:

Better Frequency Reuse Designs: Implementing improved frequency reuse designs can reduce co-channel interference. Increasing the distance between cells utilizing the same frequency range decreases the likelihood of crosstalk in mobile communication due to frequency reuse.

Reducing Cell Size: Reducing the cell size in mobile communication increases the co-channel reuse distance, leading to decreased co-channel interference. As the distance between the co-channels increases, the interference decreases.

Employing Co-Operating Transmitters: Utilizing co-operating transmitters in mobile communication can transform the interference channel into the broadcast channel, thereby mitigating co-channel interference and crosstalk.

Embodiments provide for solutions to additionally or as an alternative provide for the following technical implementations in a wireless communication environment as environments described above.
UE measures in Sub-band associated to a suspected aggressor/BWP subject to interference
UE is configured or informed together with specific resource allocation pattern (IM REs)
Note: Embodiments relate to collaborative measurement scenarios e.g. ABS, gNB coordination etc.
UE is configured or informed together with specific information about potential interference sources (Cell IDs, SSBs, . . . )—additional level of a UE being informed details about the source, e.g. by measuring RSRP
UE is configured or informed about measurement in different bands than the band it is operating in (this includes measuring in DL bands and UL bands)
Note: interference is experienced always by a victim and therefore is preferably measured by victims. However other devices nearby might also provide useful information that can identify sources of interference and their range. Embodiments thus provide for measuring victims and for such nearby devices.
UE may be configured to measure PER, BER with resource specific error allocation (soft-bits in eLLR reference). UE may trace back to radio resources which were repeatedly or sporadically (deterministically/stochastically) error prone.
Spectral measurements to be associated with the polarization, direction of arrival (beam pattern) location, orientation, time stamp, averaging, filtering, etc. in measurement report.
UE may be configured with parameters allowing to measure e.g. a power delay profile or AoA spectrum based on correlation with known signals.
UE may measure frequency offsets identifying Doppler shifts
UE may measure timing offsets identifying a different system, gNB, system configuration, . . . .

Those configurations may allow to reliably sense or detect the interference and handle or mitigate the interference.

### Proposed ICIC Solutions

Two inter-cell interference coordination (ICIC) lend their application as technical solutions to the four interference scenarios described in Section “A set of specific problems”:

### Interference Situation a) (See FIG. 25

ICIC (A)
   Allows NTN-UL w/o TN BL interference (protected slots for 23 uplink).
   NTN-UE with good channel to satellite can transmit in non-protected slot have has to be coordinated with local TN-UEs in downlink
   An example of an RRM-based solution that in which resource elements (REs) are protected using “blanking”.
   An implementation example on coordinated/collaborative RRM allowing parts of the NTN UL to be protected (CP for NTN RACCH by blanking the UL RACCH REs at the TN DL gNBs and UP for NTN UL being dynamically blanked at TN DL while other TN DL resources are used to provide the dynamically allocated TN DL BC for e.g. the SSBs of the NT gNBs. Since gNBs have there SSBs somewhere to be derived from the GSCN I assume BWPs should be excluded in the TN DL over the multiplicity of TN gNBs which can cause interference to the NTN UL. This can be done by using non-self-describing cells (BWPs or bands which are operated without SSBs and other sync supporting signals). The same should apply the NTN UL RACCH (in LTE this is at the edge of the band).

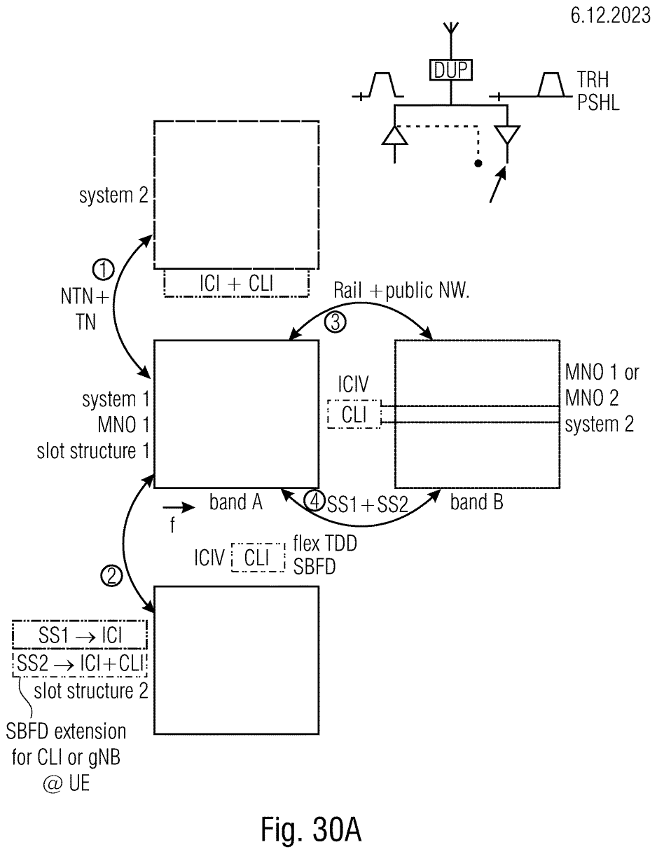

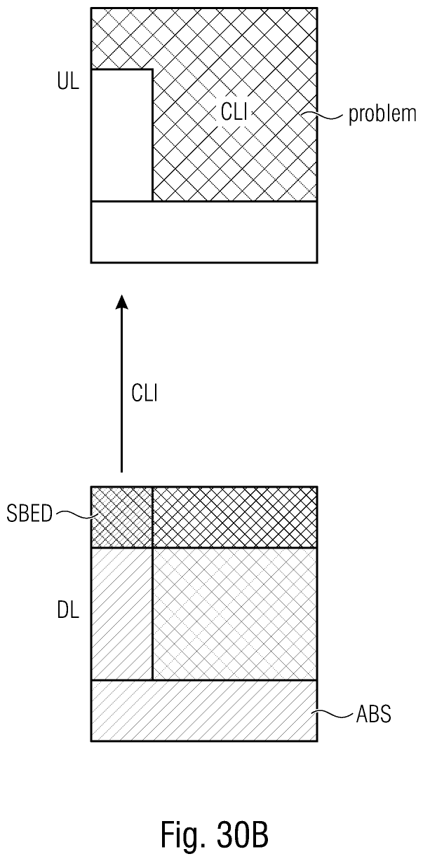

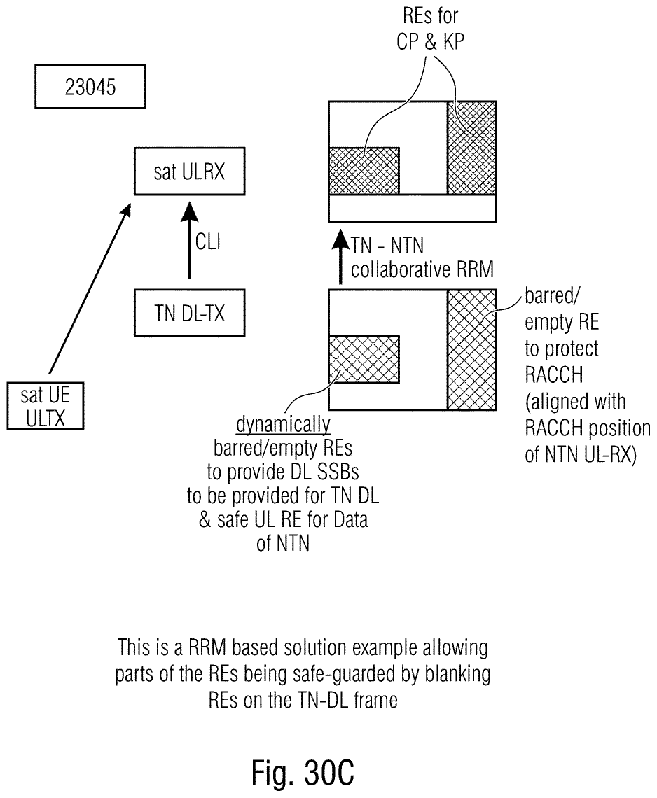

FIGS. 30A-C show a diagrammatic representation of the ICIC (A) solution proposal applied to interference solution a).

In FIG. 30C there are shown details relating to an example of an RRM-based solution that in which resource elements (REs) are protected through the use of “blanking”. FIG. 30C shows an RRM based solution example allowing parts of the REs being safe-guarded by blanking REs on the TN-DL frame. Barred or empty RE may be used to protect RACCH (aligned with RACCH position of NDM UL-RX). Dynamically bared empty REs may provide DL SSBs to be provided for TN DL and save UL RE for data of NTN.

### Interference Situation b) (See FIG. 26)

ICIC (B)
   Benefits DL n66 & 23 (across first footprint of NTN)
   Band 32 (SDL) helps to reduce n66 dependency
   An example of an RRM-based solution that in which resource elements (REs) are protected using “blanking”.
   An implementation example on coordinated/collaborative RRM allowing parts of the NTN UL to be protected (CP for NTN RACCH by blanking the UL RACCH REs at the TN DL gNBs and UP for NTN UL being dynamically blanked at TN DL while other TN DL resources are used to provide the dynamically allocated TN DL BC for e.g. the SSBs of the NT gNBs. Since gNBs have there SSBs somewhere to be derived from the GSCN I assume BWPs should be excluded in the TN DL over the multiplicity of TN gNBs which can cause interference to the NTN UL. This can be done by using non-self-describing cells (BWPs or bands which are operated without SSBs and other sync supporting signals). The same should apply the NTN UL RACCH (in LTE this is at the edge of the band).

Making reference again to FIGS. 30A-C showing also diagrammatic representation of the ICIC

(A) solution proposal applied to interference solution a).

### Interference Situation c) (See FIG. 27)

ICIC (B)
   Benefits DL n66 & 23 (across first footprint of NTN)
   Band 32 (SDL) helps to reduce n66 dependency
   An example of an RRM-based solution that in which resource elements (REs) are protected using “blanking”.
   An implementation example on coordinated/collaborative RRM allowing parts of the NTN UL to be protected (CP for NTN RACCH by blanking the UL RACCH REs at the TN DL gNBs and UP for NTN UL being dynamically blanked at TN DL while other TN DL resources are used to provide the dynamically allocated TN DL BC for e.g. the SSBs of the NT gNBs. Since gNBs have there SSBs somewhere to be derived from the GSCN I assume BWPs should be excluded in the TN DL over the multiplicity of TN gNBs which can cause interference to the NTN UL. This can be done by using non-self-describing cells (BWPs or bands which are operated without SSBs and other sync supporting signals). The same should apply the NTN UL RACCH (in LTE this is at the edge of the band).

### Interference Situation d) (See FIG. 28)

ICIC (A)
   Allows NTN-UL w/o TN BL interference (protected slots for 23 uplink).
   NTN-UE with good channel to satellite can transmit in non-protected slot have has to be coordinated with local TN-UEs in downlink
   An example of an RRM-based solution that in which resource elements (REs) are protected using “blanking”.
   An implementation example on coordinated/collaborative RRM allowing parts of the NTN UL to be protected (CP for NTN RACCH by blanking the UL RACCH REs at the TN DL gNBs and UP for NTN UL being dynamically blanked at TN DL while other TN DL resources are used to provide the dynamically allocated TN DL BC for e.g. the SSBs of the NT gNBs. Since gNBs have there SSBs somewhere to be derived from the GSCN I assume BWPs should be excluded in the TN DL over the multiplicity of TN gNBs which can cause interference to the NTN UL. This can be done by using non-self-describing cells (BWPs or bands which are operated without SSBs and other sync supporting signals). The same should apply the NTN UL RACCH (in LTE this is at the edge of the band).

Embodiments of the present invention provide for several advantages, amongst them:

Since spectrum allocation is easy to detect, it is a relatively easy scheme to show or prove over-the-air, OTA, that it is in use, thus allowing the identify of an infringing MNO to be determined. This allows NW/gNB implementations to become enforceable.

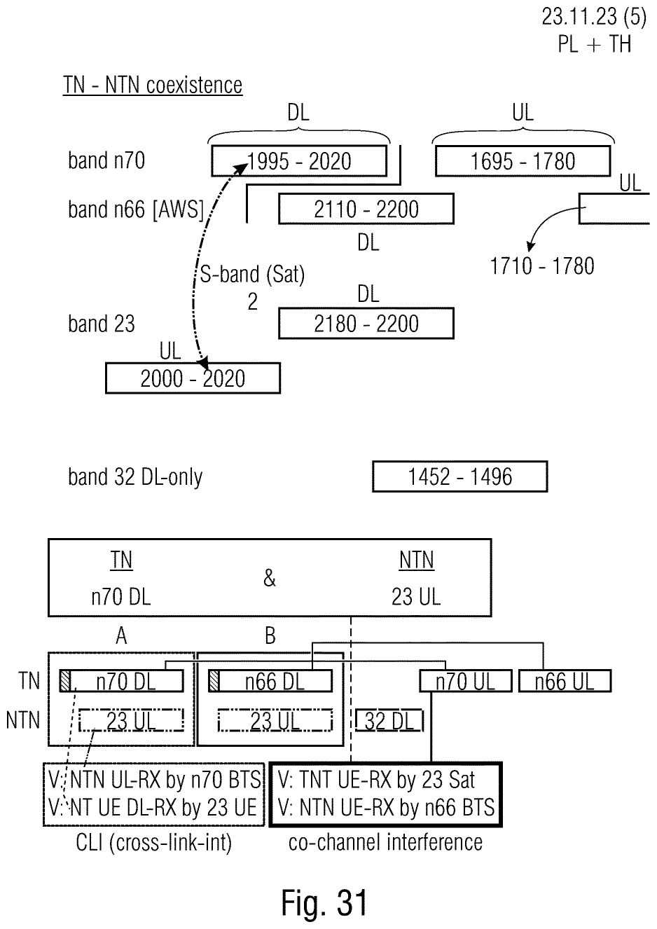

With regard to FIG. 31 a relationship between bands of a terrestrial network, TN, and of a non-terrestrial network, NTN, are shown, e.g., band number 70 in downlink (1995-2020) and in uplink (1695-1710). Overlapping with band 66 (AWS) in downlink (2110-2200) A further overlap is present for S-band (Sat) band 23 between 2000-2020 in UL, 2180-2200 in DL respectively. Amongst others, overlapping bands n70 (DL, TN) and 23 (UL, NTN), n66 (DL, TN) and 23 (DL, NTN) respectively, may be of particular interest for solutions provided by embodiments.

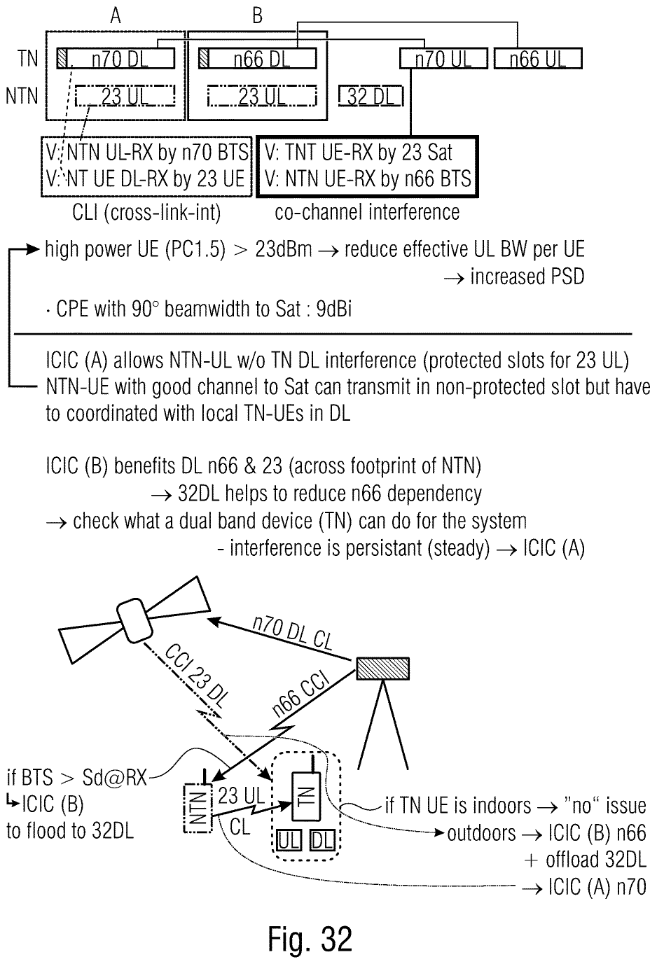

With regard to FIG. 32 V:NTN UL RX by N70 BTS; V:NT UE DL-RX by 23 UE may cause cross link interference, CLI. V:TNT UE-RX by 23 SAT, V:NTN UE-RX by N66 BTS may cause co-channel interference, V representing the victim experiencing interference caused by the respective entity.

A high power UE (PC1.5)>23 dBm may reduce the effective UL BW per UE to allow increased PSB. CPE with 90° beam width to a satellite, Sat: 9 dBi.

ICIC (A) allows NTN-UL without TNDL interference (protected slots for 23 UL). NTN-UE with good channel to SAT can transmit in non-protected slot but have to be coordinated with local TN-UEs in DL.

ICIC (B) benefits DL N 66 and 23 (across footprint of NTN). 32 DL helps to reduce N 66 dependency, embodiments relates to check what a dual band device (DN) can do for the system. Further, there is shown a satellite causing CCI in 23 DL and an NTN causing CLI in 23 UL. If a TLUE is indoors, there might be no issue outdoors, solutions relating to ICIC (B) in N66. Offload being 32 DL may relate to ICIC (A) in N 70. For example, ICIC (B) may help to offload 32 DL. As shown, a terrestrial base station may cause CLI in N70DL, in N66 as CCI.
a) N70 DL CLI. Interference is persistent (steady).
b) N66 DL CCI.
   ICIC (A) {a, d}
      Allows NTN-UL w/o TN BL interference (protected slots for 23 uplink).
      NTN-UE with good channel to satellite can transmit in non-protected slot have has to be coordinated with local TN-UEs in downlink
   ICIC (B) {b, c}
      Benefits DL n66 & 23 (across first footprint of NTN)
      Band 32 (SDL) helps to reduce n66 dependency

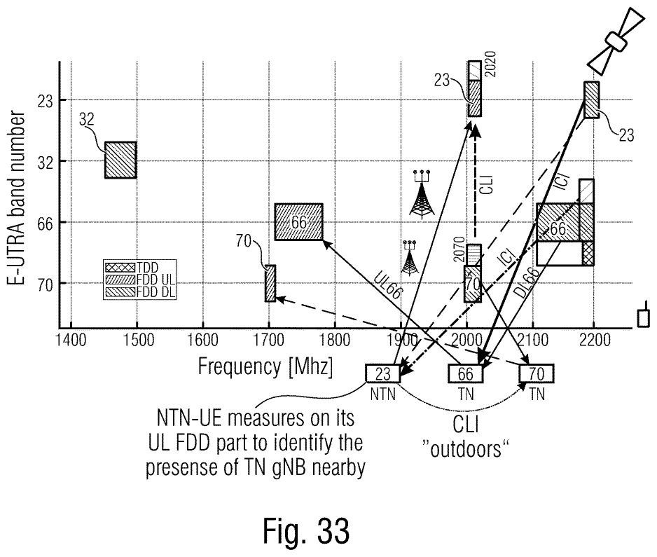

With regard to FIG. 33 showing a schematic illustration of a wireless communication scenario in accordance with embodiments, especially but not limited to the second aspect of the invention, there is shown a UE, e.g., of NTN-type, that may perform measurements on the part where it is scheduled to perform its uplink transmission, e.g., scheduled as FDD. By performing such measurements, a device or entity evaluating the measurement or a report generated therefrom may determine or evaluate whether an aggressor such as a terrestrial, TN, gNB is nearby.

### Link Between the First Aspect and the Second Aspect

As indicated above, e.g., in “A generic problem set”, aspect 1 relates to coexistence of networks that may rely on similar or even same RATs, e.g., in overlapping or adjacent spectrums. Aspect 2 may focus on a coexistence of networks that may use different RATs but possibly also in overlapping or adjacent spectrums. With regard to RF power emitted or interfering in a spectrum, the used RAT may be of some importance with regard to interference mitigation measures, however, the RF power itself may be emitted with one RAT or the other. So, when knowing the RAT, e.g., a slot structure, ort other mechanism that cause the interference may be considered when mitigating the interference regardless whether this refers to avoiding the cause of interference or the suffering therefrom, i.e., regardless whether the mechanism is implemented at the aggressor and/or the victim. When being unaware of the RAT, however, similar or other mechanism to mitigate interference or avoid the same may be used. Therefore, to solve the common problem of network coexistence, embodiments of the first aspect and of the second aspect may be combined with each other without deviating from the scope of the invention.

### Embodiments According to the Second Aspect Relate to:

According to a first implementation of the second aspect a device configured for operating in a wireless communication system and for receiving communication using reception resources, e.g., the overall reception resources or the ones (subset-static or variable) used for my own reception, is presented;
wherein the device is to measure interference in resources different from the reception resources (i.e., not only resources that are measured/received); and/or is to measure interference in resources allocated to another device for reception; and
wherein the device is to provide a measurement report from the measurement result and/or adapt an operation of the device based on the measurement result.

In connection with said first implementation, the option of providing a measurement report about the interference is just one flavour of the solution. As an example: a device could measure interference and decide to exclude or modify particular slots or REs from a CSI and CQI report, instead of reporting about the interference. Embodiments relate to specific configurations of the device by the network to measure on known of suspected slots and frequencies.

As a frequency band described herein, one may understand different things. For example, a frequency band may be or comprise an EUTRA band; an LTE band; an NR band; a channel bandwidth assignment within one of these bands; carrier bandwidths; uplink bands; downlink bands; and bandwidth parts. In addition or as an alternative there may be operated channels and the measurement of adjacent channels including first lower, second lower, first higher and second higher adjacent channel (all examples of in-band measurements). In-band measurements are also made in combination with blanking and the measurement of reference signals transmitted especially for interference assessment purposes.

According to a second implementation of the second aspect the device of implementation 1 is provided, wherein the device is to measure in at least one frequency band different when compared to a frequency band to which the reception resources are associated, e.g., measuring in DL bands and/or UL bands.

That is, the measurement can be relevant within the band the UE is operating in particular observing the SBFD slots. Here, depending on the UE capabilities and the CLI environment, a detailed CLI analysis and associated description in the reporting may be beneficial for the scheduler to make educated resource allocations.

According to a third implementation of the second aspect the device of implementation 2 is provided, wherein the frequency band relates to at least one of:
a channel of the wireless communication system or a different wireless communication system;
a frequency band used by at least one wireless communication system; and
a frequency band used for a specific radio access technology, RAT.

According to a fourth implementation of the second aspect the device of one of previous implementations is provided, wherein the device is to provide the measurement report using uplink resources associated with the reception resources; and/or
wherein the device is to provide the measurement report using resources different from the uplink resources and/or different from resources of the wireless communication system.

According to a fifth implementation of the second aspect the device of one of previous implementations is provided, wherein the reception resources are operated by at least one service providing entity such as a satellite or a base station, e.g., in a cell or by a group of service providing entities.

According to a sixth implementation of the second aspect the device of implementation 5 is provided, wherein the service providing entity, SPE, is one of:
a base station;
a relay;
a repeater;
a vehicle mounted relay, VMR;
a sidelink relay;
a reconfigurable intelligent surface, RIS;
a high-altitude platform, HAP;
an unmanned airborne vehicle, UAV; and
a satellite;
or
wherein the group of service providing entities comprises a plurality of such service providing entities.

According to a seventh implementation of the second aspect the device of one of previous implementations is provided, wherein the device is to operate in a terrestrial network, TN, and is to measure the interference of a different TN or of a non-terrestrial network, NTN.

According to an eighth implementation of the second aspect the device of one of previous implementations is provided, wherein the device is to operate in a maritime network, MN, and is to measure the interference caused by at least one of
a different MN;
a TN
an NTN; and
an aeronautical network.

According to a ninth implementation of the second aspect the device of one of previous implementations is provided, wherein the device is to operate in an aeronautical network, AN, and is to measure the interference caused by at least one of:
a different AN;
an MN;
a TN; and
an NTN.

According to a tenth implementation of the second aspect the device of one of previous implementations is provided, wherein the device is to measure the interference based on received instructions and/or based on perceiving an effect [e.g., degradation of the in-band channel] of the interference. That is, whilst many devices might experience some of the effects of one or more sources of interference, it is only those devices that suffer from these effects that can be said to be victims. According to embodiments also non-victims may be enlisted to measure interference. So, other devices in the vicinity or experiencing similar interference situations like the device in question can assist the interference assessment.

According to an eleventh implementation of the second aspect the device of one of previous implementations is provided, wherein the device is to use a duplexing filter adapted for a frequency range covering the frequency band as a first portion and additional frequency ranges as at least a second portion, wherein the device is to measure the interference at least in a part of the second portion.

According to a twelfth implementation of the second aspect the device of implementation 11 is provided, wherein the device is to use a channel selective filter for filtering the reception resource to at least partially mitigate the interference.

That is, a particular frequency selective filter at a device such as a BS or UE may allow to further constrain a transmission signal to spill into adjacent bands and to protect the band of operation from spillover of interference from adjacent bands. Such filters can be designed, but may be costly. Usually an FDD duplex separation separates the entire UL band from the DL band, but does not provide any further spectral separation of signals within each band.

According to a thirteenth implementation of the second aspect the device of one of previous implementations is provided, wherein the device is to measure, as the reception resource or in addition, in at least one of:
a sub-band associated to a suspected aggressor;
a frequency such as a bandwidth part, BWP, subject to interference, e.g., based on available interference information;
a packet error rate, PER, a bit error rate, BER, e.g., with resource specific error allocation such as soft-bits in enhanced link-level reporting;
radio resources which were repeatedly or sporadically, e.g., deterministically/stochastically, error prone;
a power delay profile and/or an angle of arrival, AoA, spectrum based on a correlation with at least one known signal, e.g., based on obtained respective information;
a frequency offset with regard to a reference, e.g., identifying a Doppler shift;
a timing offset with regard to a reference such as a different communication system, e.g., the timing offset identifying a different system, gNB (TN or NTN), a system configuration.

According to a fourteenth implementation of the second aspect the device of one of previous implementations is provided, wherein the device is to measure the interference based on at least
a received interference power;
a received resource allocation pattern (interference measurement resource elements IM Res);
a received information indicating a potential interference sources, the information containing, e.g., a Cell IDs, a synchronization signal block, SSB, . . . .

According to a fifteenth implementation of the second aspect the device of one of previous implementations is provided, wherein the device is to measure the interference as a spectral measurement, wherein the device is to provide the report or to derive interference information forming a basis for adapting the operation to comprise
information indicating a polarization, a direction of arrival, a recognized beam pattern, a location, an orientation, a time stamp, a measurement value obtained by averaging, a measurement value obtained by filtering, and the information being associated with the spectral measurement.

According to a sixteenth implementation of the second aspect the device of one of previous implementations is provided, wherein the device is to measure the interference as a temporal measurement in at least one time resource such as a time slot or an OFDM-symbol of the wireless communication system, wherein the device is to provide the report or to derive interference information forming a basis for adapting the operation to comprise
information indicating a polarization, a direction of arrival, a recognized beam pattern, a location, an orientation, a time stamp, a measurement value obtained by averaging, a measurement value obtained by filtering, and the information being associated with the spectral measurement.

According to a seventeenth implementation of the second aspect the device of one of implementation 16 or 17 is provided, wherein the device or a device receiving the report is adapted to identify a source of the interference based on the interference information, e.g., identifying a satellite.

According to an eighteenth implementation of the second aspect the device of one of previous implementations is provided, wherein the device is one of:
a base station;
a relay;
a repeater;
a vehicle mounted relay, VMR;
a sidelink relay;
a reconfigurable intelligent surface, RIS;
a high-altitude platform, HAP;
an unmanned airborne vehicle, UAV; and
a satellite.

According to a nineteenth implementation of the second aspect a wireless communication scenario comprising:
a first service providing entity, adapted to provide a wireless communication service using a first set of resources and for a first set of terminal devices;
at least a second service providing entity, adapted to provide a wireless communication service using a second set of resources for a second set of terminal devices;
a coordinating device adapted for obtaining at least one measurement report indicating, e.g., as option 1, a first interference perceived by the first service providing entity or a terminal of the first set of terminals based on an operation of the second service providing entity or a terminal of the second set of terminals; and/or (e.g., as option 2) a second interference perceived by the second service providing entity or a terminal of the second set of terminals based on an operation of the first service providing entity or a terminal of the first set of terminals;
wherein the coordinating device is for providing a resource allocation information indicating a resource allocation for at least one of the first and second service providing entities to mitigate the first and/or second interference. For example, each SPE may “evade” perceived interference and/or change its allocation to reduce interference caused.

According to a twentieth implementation of the second aspect the wireless communication scenario of implementation 19 is provided, wherein at least a subset of the first set of terminal devices having one or more terminals; and/or wherein at least a subset of the second set of terminal devices having one or more terminals have a common mobility behaviour, e.g., they are travelling in or at a same vehicle.

According to a twenty-first implementation of the second aspect the wireless communication scenario of implementation 19 or 20 is provided, wherein the coordinating entity is to provide the resource allocation information to obtain an overall optimization of at least one communication parameter (PER, BER, delay, number of retransmissions, . . . ) for the first and second service providing entity and for the first and/or second set of terminals.

According to a twenty-second implementation of the second aspect the wireless communication scenario of one of implementations 19 to 21 is provided, wherein the first service providing entity is configured for an operation of a terrestrial network; and wherein the second service providing entity is configured for an operation of a non-terrestrial network or a railway-network.

According to a twenty-third implementation of the second aspect the wireless communication scenario of one of implementations 19 to 22 is provided, wherein the first service providing entity is configured for an operation of a first type of one of the following:
a TN;
a maritime network, MN;
an aeronautical network, AN;
and wherein the second service providing entity is configured for an operation of a different type of one of the following:
a TN;
a maritime network, MN;
an aeronautical network, AN.

According to a twenty-fourth implementation of the second aspect the wireless communication scenario of one of implementations 19 to 23 is provided, comprising
at least a third service providing entity, adapted to provide a wireless communication service using a third set of resources and for a third set of terminal devices;
wherein the third service providing entity is configured for an operation of a same or different type networks when compared to the first and second service providing entity.

According to a twenty-fifth implementation of the second aspect the wireless communication scenario of one of implementations 19 to 24 is provided; wherein the a first service providing entity or the second service providing entity is adapted to operate a stationary or a moveable network such as an AN, MN, NTN or TN.

A Motivation for this is to ensure that embodied networks (and not just the UEs that the network serves) can be either fixed or mobile or are sometimes fixed and are sometimes mobile. The railway WCS is one example of a (terrestrial) network that moves into and out of the coverage footprint of other networks (e.g. other terrestrial or non-terrestrial networks). When the train comes to a station or is stopped enroute by a signal, the moving railway network ceases moving inside of other (moving or non-moving) networks. It should also be noted that when a moving network moves, its speed might change too. For the example of the train, not only should it be possible to predict the route of the train but it might also be possible to estimate its speed along the route. The two pieces of information can be combined to predict the train's position at a given time. Similar arguments hold true for other moving networks (buses, lorries, boats, ships, aeroplanes, satellites, etc.)

According to a twenty-sixth implementation of the second aspect the wireless communication scenario of implementation 25 is provided, wherein the coordinating node/device/entity is adapted to coordinate the first service providing entity and/or the second service providing entity under consideration of a speed of a moveable network or a predicted position of a moveable network with regard to a coverage of a network operated by the other service providing entity.

According to a twenty-seventh implementation of the second aspect the wireless communication scenario of one of implementations 19 to 26 is provided, wherein the first service providing entity is configured for an operation of a public network, e.g., a terrestrial network; and wherein the second service providing entity is configured for an operation of a private network such as a wireless campus network.

According to a twenty-eighth implementation of the second aspect the wireless communication scenario of one of implementations 19 to 27 is provided,
wherein the resource allocation information indicates resources used by at least one of the first service providing entity and the first set of terminals that are to be avoided by at least one of the second service providing entity and the second set of terminals; and/or
wherein the resource allocation information indicates resources used by at least one of the second service providing entity and the second set of terminals that are to be avoided by at least one of the first service providing entity and the first set of terminals.

According to a twenty-ninth implementation of the second aspect the wireless communication scenario of one of implementations 19 to 28 is provided, wherein the wireless communication scenario is adapted to instruct a plurality of terminals from the first set of terminals or a device communicating therewith and/or from the second set of terminals or a device communicating therewith for a collaborative measurement scenario to obtain a plurality of measurement reports and/or to adapt an operation of the terminal/device based on a measurement result.

According to a thirtieth implementation of the second aspect the wireless communication scenario of one of implementations 19 to 29 is provided, wherein at least one of the first service providing entity, the second service providing entity, a terminal of the first set of terminals and a terminal of the second set of terminals is in accordance with one of implementations 1 to 18.

According to a thirty-first implementation of the second aspect the wireless communication scenario of one of implementations 19 to 30 is provided, wherein the first interference is one of inter-cell-interference, ICI, and cross-link-interference, CLI; and
wherein the second interference is one of ICI and CLI.

According to a thirty-second implementation of the second aspect a coordinating device for operating in a wireless communication scenario such as a wireless communication scenario according to one of implementations 19 to 31 is provided, wherein the coordinating entity is to obtain at least one measurement report indicating, e.g., as option 1 a first interference perceived by a first service providing entity or a terminal of a first set of terminals of the wireless communication scenario based on an operation of the second service providing entity or a terminal of the second set of terminals using a second set of resources; and/or (e.g., as option 2) a second interference perceived by a second service providing entity or a terminal of a second set of terminals wireless communication scenario based on an operation of the first service providing entity or a terminal of the first set of terminals using a first set of resources; and
wherein the coordinating device is for providing a resource allocation information indicating a resource allocation for at least one of the first and second service providing entity to mitigate the first and/or second interference. For example, each SPE may “evade” perceived interference and/or change its allocation to reduce interference caused.

According to a thirty-third implementation of the second aspect a method for operating a device in a wireless communication system is provided, the method comprising:
receiving communication with the device using reception resources;
measuring, with the device, interference in resources different from the reception resources;
and/or measure interference in resources allocated to another device for reception; and
providing a measurement report from the measurement result and/or adapting an operation of the device based on the measurement result.

According to a thirty-fourth implementation of the second aspect a method for operating a wireless communication scenario is provided, the method comprising:
operating a first service providing entity to provide a wireless communication service using a first set of resources and for a first set of terminal devices;
operating at least a second service providing entity to provide a wireless communication service using a second set of resources for a second set of terminal devices;
operating a coordinating device for obtaining at least one measurement report indicating, e.g., as option 1, a first interference perceived by the first service providing entity or a terminal of the first set of terminals based on an operation of the second service providing entity or a terminal of the second set of terminals; and/or, e.g., as option 2, a second interference perceived by the second service providing entity or a terminal of the second set of terminals based on an operation of the first service providing entity or a terminal of the first set of terminals;
providing a resource allocation information indicating a resource allocation for at least one of the first and second service providing entities to mitigate the first and/or second interference.

According to a thirty-fifth implementation of the second aspect a method for operating a coordinating device in a wireless communication scenario is provided, the method comprising:
obtaining at least one measurement report indicating, e.g., as option 1, a first interference perceived by a first service providing entity or a terminal of a first set of terminals of the wireless communication scenario based on an operation of the second service providing entity or a terminal of the second set of terminals using a second set of resources; and/or, e.g., as option 2, a second interference perceived by the second service providing entity or a terminal of the second set of terminals wireless communication scenario based on an operation of the first service providing entity or a terminal of the first set of terminals using a first set of resources; and
providing a resource allocation information indicating a resource allocation for at least one of the first and second service providing entity to mitigate the first and/or second interference.

According to a thirty-sixth implementation of the second aspect a computer readable digital storage medium having stored thereon a computer program having a program code for performing, when running on a computer, a method according to one of implementations 33 to 35 is provided.

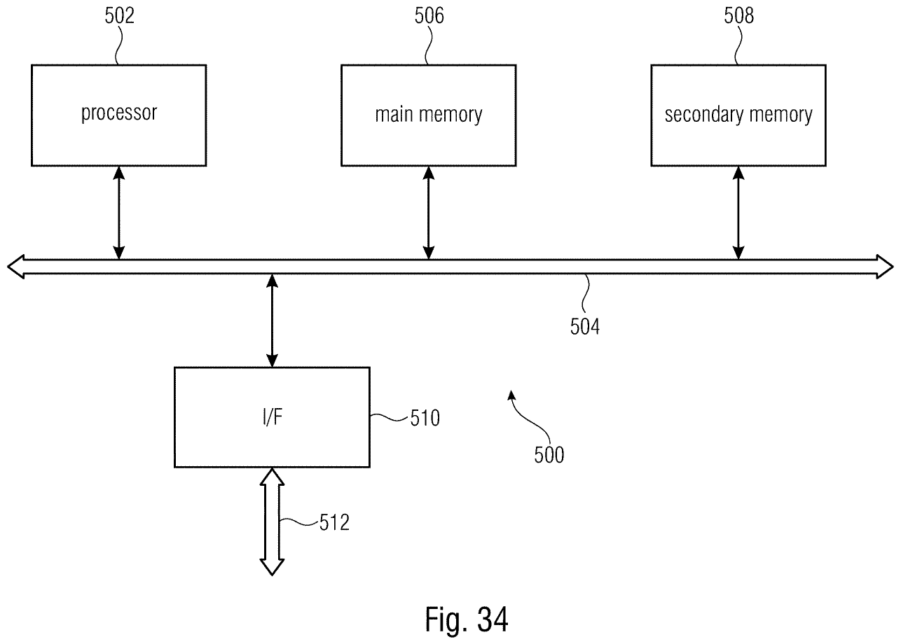

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 34 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

| Abbreviation | Definition | Further description |
|---|---|---|
| 2G | second generation | |
| 3G | third generation | |
| 3GPP | third generation | |
| | partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCI | co-channel interference | |
| CCO | coverage and capacity | |
| | optimization | |
| CHO | conditional handover | |
| CLI | cross-link interference | |
| CLI-RSS | cross-link interference | |
| | received signal | |
| CP | control plane | |
| CP1 | control plane 1 | |
| CP2 | control plane 2 | |
| CPRI | common public radio interface | |
| CSI-IM | channel state information | |
| | interference | |
| | measurement | |
| CSI-RS | channel state information | |
| | reference | |
| CU | central/centralized unit | |
| D2D | device-to-device | |
| DAPS | dual active protocol stack | |
| DAC | digital-to-analogue converter | |
| DC-CA | dual-connectivity | |
| | carrier aggregation | |
| DECT | digitally enhanced | |
| | cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global | |
| | identifier | |
| E-CID | enhanced cell ID | |
| eCPRI | enhanced CPRI | |
| eICIC | enhanced ICIC (see ICIC) | |
| eMBB | enhanced mobile broadband | |
| eNB | evolved Node b | |
| EN-DC | e-UTRAN-New Radio | |
| | dual connectivity | |
| EUTRA | enhanced UTRA | |
| E-UTRAN | enhanced UTRA network | |
| FSS | frequency-selective surface | |
| gNB | next generation NodeB | |
| GNSS | global navigation | |
| | satellite system | |
| GPS | global positioning system | |
| GSO | geostationary orbit | |
| HAPS | high-altitude platforms | |
| HARQ | hybrid ARQ | |
| IAB | integrated access and backhaul | |
| ICI | Inter-carrier interference | |
| | inter-channel interference | |
| ICIC | inter-cell interference | |
| | cancellation | |
| ICN | information centric network | |
| ID | identity/identification | |
| IF | intermediate frequency | |
| IIOT | industrial internet of things | |
| IMT | international mobile | |
| | telecommunications | |
| ITU | international | |
| | telecommunications union | |
| KPI | key-performance indicator | |
| LTE | long-term evolution | |
| MBB | mobile broadband | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-rat dual connectivity | |
| MSS | mobile satellite service | |
| NB-IoT | narrow-band Internet-of-things | |
| NCGI | new radio cell global | |
| | identifier | |
| NEF | network exposure function | |
| NG | next generation | |
| ng-eNB | next generation eNB | node providing E-UTRA |
| NG-RAN | either a gNB or an NG-eNB | |
| NGSO | non-geostationary orbit | |
| NIC | network interface connection | |
| NR | new radio | |
| NR-U | NR unlicensed | NR operating in |
| | | unlicensed |
| NTN | non-terrestrial network | |
| OAM | operation and | |
| | maintenance | |
| OEM | original equipment | |
| | manufacturer | |
| OTT | over-the-top | |
| oRAN | see open RAN | |
| Open RAN | open radio access network | |
| PCI | physical cell identifier | Also known as PCID |
| PDCP | packet data | |
| | convergence protocol | |
| PER | packet error rate | |
| PHY | physical | |
| PLMN | public land mobile network | |
| QCL | quasi colocation | |
| QOS | quality of service | |
| RA | random access | |
| RACH | random access channel | |
| RAN | radio access network | |
| RAT | radio access technology | |
| RE | resource element | |
| RF | radio frequency | |
| RIM | radio access | |
| | network information | |
| RIM-RS | rim reference signal | |
| RIS | reconfigurable | |
| | intelligent surface | |
| RISC | RIS controller | |
| RLC | radio link control | |
| RLF | radio link failure | |
| RLM | radio link monitoring | |
| RP | reception point | |
| R-PLMN | registered public | |
| | land mobile network | |
| RRC | radio resource control | |
| RRU | remote radio unit | |
| RS | reference signal | |
| RSRP | reference signal | |
| | received power | |
| RSRQ | reference signal | |
| | received quality | |
| RSSI | received signal | |
| | strength indicator | |
| RSTD | reference signal | |
| | time difference | |
| RTOA | relative time of arrival | |
| RTT | round trip time | |
| RU | radio unit | |
| SA | standalone | |
| SCEF | service capability | |
| | exposure function | |
| SCG | secondary cell group | |
| SDU | service data unit | |
| SES | satellite earth station | |
| SIB | system information block | |
| SINR | signal-to-interference- | |
| | plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | sounding reference indication | |
| SS | synchronization signal | |
| SSB | synchronization signal block | |
| SSID | service set identifier | |
| SS-PBCH | sounding signal/ | |
| | physical broadcast | |
| TAC | tracking area code | |
| TB | transmission block | |
| TCI | transmission configuration | |
| | indication | |
| TDD | time division duplex | |
| TN | terrestrial network | |
| TSG | technical specification group | |
| UAV | unmanned airborne vehicle | |
| UE | user equipment | |
| UL | uplink | |
| UF | user plane | |
| URI | uniform resource identifier | |
| URL | uniform resource locator | |
| URLLC | ultra-reliable low | |
| | latency communication | |
| UTRAN | universal trunked radio | |
| | access network | |
| V2X | vehicle-to-everything | |
| VoIP | voice over internet protocol | |
| vRAN | virtual ran | |
| WI | work item | |
| WLAN | wireless local area network | |
| WRC | world radio congress | |

1. A wireless communication scenario comprising:
a first wireless communication system, WCS, adapted to provide wireless communication to a plurality of communication devices in a first communication area;
a second wireless communication system, WCS, adapted to provide wireless communication to a plurality of communication devices; in a second communication area;
wherein the first WCS and/or the second WCS provide a source of inter-WCS interference for the respective other WCS;
wherein the wireless communication scenario is adapted to mitigate the inter-WCS interference.

2. The wireless communication scenario of claim 1, wherein the second communication area is located adjacent to or overlapping with the first communication area.

3. The wireless communication scenario of claim 1, wherein signals of the first WCS cause inter-WCS interference for the second WCS and/or signals of the second WCS cause inter-WCS interference for the first WCS.

4. The wireless communication scenario of claim 1, wherein the inter-WCS interference comprises at least one of:
a cross-link interference from the first WCS to the second WCS, e.g., a BS of the first WCS operates in Downlink and a BS of the second WCS operates in uplink;
an inter-cell interference from the first WCS to the second WCS, e.g., a BS of the first WCS operates in downlink and a UE of the second WCS operates in downlink;
an inter-cell interference from the first WCS to the second WCS, e.g., a UE of the first WCS operates in uplink and a BS of the second WCS operates in uplink
a cross-link interference from the first WCS to the second WCS, e.g., a UE of the first WCS operates in uplink and a UE of the second WCS operates in downlink;
a cross-link interference from the second WCS to the first WCS, e.g., a BS of the second WCS operates in downlink and a BS of the first WCS operates in uplink
an inter-cell interference from the second WCS to the first WCS, e.g., a BS of the second WCS operates in downlink and a UE of the first WCS operates in downlink;
an inter-cell interference from the second WCS to the first WCS, e.g., a UE of the second WCS operates in uplink and a BS of the first WCS operates in uplink;
a cross-link interference from the second WCS to the first WCS, e.g., a UE of the second WCS operates in uplink and a UE of the first WCS operates in downlink.

5. The wireless communication scenario of claim 1, wherein the first WCS and the second WCS are operated in adjacent, overlapping or non-overlapping frequency ranges and/or are operated with a same radio access technology, RAT.

6. The wireless communication scenario of claim 1, wherein the first WCS and the second WCS are operated by a same operator such as a mobile network operator, MNO.

7. The wireless communication scenario of claim 1, wherein the first WCS and the second WCS are operated by different operators such as mobile network operators, MNOs.

8. The wireless communication scenario of claim 1, wherein the first WCS and the second WCS operate on at least one same carrier frequency to provide wireless communication.

9. The wireless communication scenario of claim 8, wherein the first WCS and the second WCS are operated by a same operator such as a mobile network operator, MNO; wherein the first WCS and the second WCS are adapted to provide the communication to a common plurality of devices; wherein a coordination entity of the wireless communication scenario is adapted to control at least a part of the first WCS and a part of the second WCS to mitigate the inter-WCS interference.

10. The wireless communication scenario of claim 8, wherein the first WCS and the second WCS are operated by different operators such as mobile network operators, MNOs; wherein the wireless communication scenario comprises a coordination unit adapted for providing coordination for the first WCS and/or the second WCS; wherein a controlling entity of the wireless communication scenario is adapted to control at least a part of the first WCS and/or a part of the second WCS to mitigate the inter-WCS interference.

11. The wireless communication scenario of claim 8, wherein at least one device communicating in the wireless communication scenario is adapted to measure and report perceived interference to provide a basis for controlling the at least part of the first WCS or part of the second WCS to mitigate the inter-WCS interference.

12. The wireless communication scenario of claim 1, wherein the first WCS and the second WCS operate on at least one different carrier frequency to provide wireless communication.

13. The wireless communication scenario of claim 12, comprising a coordinating entity adapted for joint coordination of a schedule of a first carrier used in the first WCS and of a second carrier used in the second WCS, e.g., to provide inter-carrier coordination.

14. The wireless communication scenario of claim 12, wherein the first WCS and the second WCS are operated by a same operator such as a mobile network operator, MNO; wherein at least one base station of at least one of the first WCS and the second WCS is adapted for a cross-carrier measurement to measure on a carrier unused by the base station and/or to operate according to a cross-carrier scheduling to mitigate the inter-WCS interference.

15. The wireless communication scenario of claim 12, wherein the first WCS and the second WCS are operated by different operators such as mobile network operators, MNOs; wherein the wireless communication scenario comprises a coordination unit adapted for providing coordination for the first WCS and/or the second WCS; wherein a controlling entity of the wireless communication scenario is adapted to control at least a part of the first WCS and/or a part of the second WCS to mitigate the inter-WCS interference.

16. The wireless communication scenario of claim 15,
wherein the coordination unit is adapted for providing information to the second WCS, the information indicating a scheduling of the first WCS on at least one carrier to enable a controller of the second WCS to adjust a scheduling of the second WCS with regard to the scheduling first WCS to mitigate the inter-WCS interference; and/or
wherein the coordination unit is adapted for providing information to the first WCS, the information indicating a scheduling of the second WCS on at least one carrier to enable a controller of the first WCS to adjust a scheduling of the first WCS with regard to the scheduling second WCS to mitigate the inter-WCS interference.

17. The wireless communication scenario of claim 1, adapted for measuring an inter-carrier interference present between the first and second wireless communication system, WCS, operated by same or different MNOs; and for mitigating the inter-carrier interference.

18. The wireless communication scenario of claim 1,
wherein a base station of the first WCS is adapted to use a first set of reference signals using first dedicated time/frequency resources; wherein the first dedicated time frequency resources are known by the second WCS; wherein a member of the second WCS is adapted to measure the first set of reference signals to provide a basis for mitigating the inter-WCS interference; and/or
wherein a base station of the second WCS is adapted to use a second set of reference signals using second dedicated time/frequency resources; wherein the second dedicated time frequency resources are known by the first WCS; wherein a member of the first WCS is adapted to measure the second set of reference signals to provide a basis for mitigating the inter-WCS interference.

19. The wireless communication scenario of claim 1,
wherein a member of at least one WCS is adapted to measure a perceived interference and for providing a measurement report for a coordinating entity adapted to coordinate at least a part of the wireless communication scenario to mitigate the inter-WCS interference.

20. The wireless communication scenario of claim 19,
wherein the member is adapted for measuring and reporting an inter-WCS cross-link interference; and/or
wherein the member is adapted for measuring and reporting an inter-WCS inter-cell interference.

21. The wireless communication scenario of claim 1,
wherein a member of at least one WCS is adapted to measure a perceived interference and optionally for providing a measurement report wherein at least one of the member, i.e. the measuring/reporting member and/or an entity receiving the report is configured for adapting at least a part of the WCS in response to the measurement or the report.

22. The wireless communication scenario of claim 1, comprising a coordination unit, wherein a coordination unit is adapted for providing at least one of:
an inter-RAT coordination of the first WCS and the second WCS;
an inter-MNO coordination between a first mobile network operator, MNO, operating the first WCS and a second MNO operating the second WCS
an inter-cell coordination between cells of a same or different WCS;
a slot structure coordination between different TDD/sub-band full duplex, SBFD slot structures of a cell; and
an inter-cell coordination operating in different sub-band full duplex configurations (SBFD).

23. The wireless communication scenario of claim 22, wherein, to provide coordination, the coordination unit is adapted to controlling at least one entity of the first WCS and/or the second WCS or for providing information to a controller of one of the first WCS and second WCS about the respective other WCS.

24. The wireless communication scenario of claim 22, wherein the coordination unit is adapted for providing an enhanced inter-cell interference coordination, eICIC being intra-carrier, intra-MNO and/or inter-cell, e.g. macro-picocell coordination.

25. The wireless communication scenario of claim 1, wherein the first WCS is operated as a mobile communication network in one of a time division duplex, TDD, frequency division duplex, FDD, Sub-band full duplex (SBFD) and/or full duplex scheme; and/or wherein the first WCS is operated as a mobile communication network in one of a time division duplex, TDD, frequency division duplex, FDD, Sub-band full duplex (SBFD) and/or full duplex scheme

26. The wireless communication scenario of claim 1, wherein one of the first WCS and the second WCS, when perceiving, as a victim, the inter-WCS interference from the other WCS as an aggressor, is adapted for determining a communication device suffering from the inter-WCS interference, e.g., above a threshold value, and for scheduling the suffering communication device to a communication resource being less affected by the inter-WCS interference from the perspective of the suffering device.

27. The wireless communication scenario of claim 1, wherein one of the first WCS and the second WCS, when perceiving, as a victim, the inter-WCS interference from the other WCS as an aggressor, is adapted for determining an interference information indicating at least one of:
the inter-WCS interference is based on different TDD slot structures operated in at least parts of the first WCS and the second WCS
only a subset of communication devices experiences significant interference from the aggressor,
only a subset of downlink, DL, time resources such as DL slots, frames, symbols, used by the victim experience significant interference from the aggressor;
only a subset of DL frequency resources such as carriers, DL BWPs or DL spectral resources used by the victim experience significant interference from the aggressor;
only a subset of DL channels such as user plane, UP or control plane, CP, channels, used by the victim experience significant interference from the aggressor;
only a subset of uplink, UL, time resources such as UL slots, frames, symbols, used by the victim experience significant interference from the aggressor;
only a subset of UL frequency resources such as carriers, UDL BWPs or UL spectral resources used by the victim experience significant interference from the aggressor;
only a subset of UL channels such as user plane, UP or control plane, CP, channels, used by the victim experience significant interference from the aggressor.

28. The wireless communication scenario of claim 27, wherein a controller of the victim is adapted for, based on the interference information, at least one of:
L schedule any communication device on “unaffected” or “moderately affected” radio resources, e.g. DL slots which are simultaneously operated by a 1^{st} WCS and a 2^{nd} WCS;
schedule unaffected or moderately affected communication devices, e.g. a UE which is indoors and therefore better isolated from an interfering base station outdoors, or groups thereof onto any radio resources available to the victim which have been identified due to individual reports of the communication devices, to be suitable for DL use;
schedule system information or user specific information, e.g. CORESETs or other control channels into radio resources which are unaffected or moderately affected by the inter-WCS interference from the aggressor.

29. The wireless communication scenario of claim 27, wherein the controller of the victim is adapted, based on the interference information, for at least one of:
controlling the victim to provide interference measurements of the victim more frequently,
applying statistical interference mitigation techniques such as frequency hopping, coding over longer periods, repetition coding, low MCS modes, etc.,
applying interference pattern identification and prediction methods, and
applying a priori knowledge about future interference scenarios on radio resources or about communication devices, e.g., through interference coordination by e.g. beam coordination or coordinated patterns of radio resources between the victim and the aggressor.

30. The wireless communication scenario of claim 27, wherein a controller of the victim or of the aggressor is adapted for observing and learning a pattern or behaviour, e.g., of its own and/or of the other WCS, and its associated interference impact onto at least one of its communication devices or entities;
for predicting future availability or resources or interference impact onto at least one of its communication devices or entities;
for applying appropriate radio resources allocation or user scheduling strategies to mitigate expected interference impacts.

31. The wireless communication scenario of claim 1, wherein one of the first WCS and the second WCS, when perceiving, as a victim, the inter-WCS interference from the other WCS as an aggressor, is adapted for determining interference information indicting at least one of:
information indicating that many or a dominant number of communication devices of the victim experience significant interference from the aggressor on a share being at least a threshold, e.g., most or all radio resources available to the victim; e.g., a situation where no or insufficient number of safe or unaffected radio resources are available to serve many users or the communication devices,
particular Downlink, DL, time resources such as DL slots, frames, symbols, used by the victim, e.g. SSBs experience significant interference from the aggressor or at least a considerable number thereof, e.g., an insufficient number of time resources considered to be safe-guarded,
particular DL frequency resources such as carriers, DL BWPs or DL spectral resources used by the victim, e.g. SSBs experience significant interference from the aggressor or at least a considerable number thereof, e.g., insufficient number of time resources considered to be safe-guarded,
important/system relevant/system performance relevant DL channels such as user plane, UP, and/or Control plane, CP, channels used by the victim experience significant interference from the aggressor,

32. The wireless communication scenario of claim 27, wherein a controller of the victim is adapted for, based on the interference information, at least one of:
contributing to a radio resource coordination between the victim and the aggressor;
safeguarding certain radio resources for the victim or the aggressor, e.g.,
applying semi-persistent radio resource allocations for TDD slot configurations, SBFD configurations, beam directions, beam allocation orders, power spectral densities, transmit power, muting of RE, BWPs, slots etc. (system information exchange between the two WCSs might be sufficient when done once, occasionally, request-based or event-based, when system information changes have been made).
Exchange of future radio resource allocations between the victim and the aggressor;
Operating according to an aligned or coordinated behaviour or configuration of the victim and the aggressor to allow a sufficient number of radio resources available for at least one of the two WCS, sufficient number of communication devices belonging to at least one WCS to be served reliably according to a targeted service level (QoS) of that particular WCS;
At least one of the WCSs observes and learns patterns or behaviour and its associated interference impact onto at least one of its devices or entities and predicts future availability of resources or interference impact onto at least one of its devices or entities and applies appropriate radio resources allocation or user scheduling strategies to mitigate expected interference impacts.

33. The wireless communication scenario of claim 31, wherein a controller of the victim or of the aggressor is adapted for observing and learning a pattern or behaviour, e.g., of its own and/or of the other WCS, and its associated interference impact onto at least one of its communication devices or entities.

34. The wireless communication scenario of claim 33, wherein the victim and the aggressor are adapted for evaluating a coordination mechanism regarding its effectiveness and/or efficiency for mitigating the inter-WCS interference in order to coordinate the coordination mechanism with the other WCS.

35. The wireless communication scenario of claim 1, wherein the inter-WCS interference is constant, quasi-static, semi-persistent or gradually/slowly changing.

36. The wireless communication scenario of claim 1, wherein the first WCS and the second WCS are adapted to implement at least one of:
operating based on a same radio access technology, RAT;
operating based on time division duplexing (TDD);
operating based on sub-band full duplexing (SBFD);
operating based on a hybrid combination of any of FDD, SBFD and TDD;
operating based on a TDD scheme that is similar or different to the TDD scheme of the other WCS;
operating based on a SBFD scheme that is similar or different to the SBFD scheme of the other WCS;
operating based on a hybrid scheme that is similar or different to the hybrid scheme of the other WCS;
being operating by the same or a different mobile network operator (MNO) as the other WCS.

37. A communication device, operating in the first WCS or the second WCS a wireless communication scenario of claim 1.

38. A coordinating node, operating in the first WCS or the second WCS a wireless communication scenario of claim 1.

39. A method for operating at least one device of the first WCS or the second WCS a wireless communication scenario of claim 1.

40. A computer readable digital storage medium having stored thereon a computer program having a program code for performing, when running on a computer, a method according to claim 39.
